(19) United States
(12) Patent Application Publication
(10) Pub. No.: US 2021/0026862 A1
(43) Pub. Date: Jan. 28, 2021

(54) METHODS AND SYSTEMS FOR INDEXING AND ACCESSING DOCUMENTS OVER CLOUD NETWORK

(71) Applicant: SynerScope B.V., Helvoirt (NL)

(72) Inventor: Jorik BLAAS, Helvoirt (NL)

(21) Appl. No.: 16/520,122

(22) Filed: Jul. 23, 2019

(51) Int. Cl. G06F 16/25; G06F 16/22; G06F 16/93

(52) U.S. Cl. CPC G06F 16/254; G06F 16/93; G06F 16/2255

(57) ABSTRACT

Some embodiments are directed to methods and apparatus for accessing indexing and accessing documents over cloud network is disclosed. The method may include allocating a bit array of a predetermined size in a memory, and constructing a bloom filter based on the bit array, wherein each of a plurality of values in the bit array is hashed. The method may further include determining density of the bloom filter, and iteratively tuning the bit array until the density of the bloom filter is greater than a predetermined density level. The method may further include storing the tuned bit array in a storage folder; wherein a plurality of bit arrays of same size are grouped together.

### BACKGROUND

This disclosure relates generally to searching documents and databases, and some embodiments are directed to methods and systems for indexing and searching documents using cloud-native services.

As the sheer volume of online data has increased, the importance of searching for and finding documents, the “needle in the haystack” problem, has grown enormously. Some approaches to this problem are versions of time-honored solutions developed for print documents. Filing documents into folders or creating an index of terms or tags and using those structures to find documents. Particularly, on the web, alternative approaches make opportunistic or parasitic use of human activity to organize documents, for instance by linkage patterns (PageRank) or using keywords extract from URLs or document titles. All of these approaches rely on some kind of registration of the underlying data based on human activity. As a result, they are unlikely to capture or identify novel or unlikely correlations and relations.

Some related art methods/apparatus may use the data or content itself for building profiles, indexes and linkages based on components of the content (for example table cells) or transformed components (for example, stemmed content words). However, these techniques generally require fast searches of inverted indexes from these component values. As will be appreciated by those skilled in the art, these techniques are used by related art full-text search solutions such as SOLR or Elastic Search. However, these solutions may not work with large amounts of data formatted in tables containing large numbers (in millions) of component values (cell values, textual words or phrases). Because of their use of inverted indexes to documents, the related art tends to use significant resources, especially data memory, of data for search.

Because related art techniques may require heavy memory, multiple nodes and attached disks, these related art techniques may not be suited for cloud computing contexts (the “lambda/kappa” domains), where tasks are divided into operations which are executed on lightweight non-persistent compute threads. This makes it difficult for those operations to rely on search-based algorithms in large data sets.

### SUMMARY

It may therefore be advantageous to address one or more of the issues identified above, such as by using hashing to reduce/minimize memory pressure of data or document search. Hashing is a technique which uses a special function (called the hash function) which is used to map a given value into an integer or bit array to enable faster search or comparison within a database. For example, “bloom filters” (a data structure) use a second level of hashing, from integers or bit arrays to bit positions, to enable very fast determination of set membership (whether a given value is in an enumerated set) with relatively low memory requirements.

It may also be advantageous to address one or more of the issues identified above, by reducing the size of generated bloom filters to further reduce/minimize memory pressure when searching for data components. One technique for this reduction is “hash folding” which reduces the size of bit array representations, and hence pressure on memory usage, by folding the last half of the array into the first half of the array and “OR”ing the bits together. Because hash-based algorithms are probabilistic (they may generate false positives) based on their density (the number of “1” bits in the array), bit array reduction can be used to reduce memory requirements to meet an acceptable expected error rate.

It may also be advantageous to address one or more of the issues identified above by using transposition to reduce/minimize memory pressure while retrieving data. Hash-based search algorithms often test only a few bits from each bit array. When many bit arrays of the same size are given, it is better to put all bits that are in the same position number next to each other, as a single read operation can then retrieve all of the bits at position N over many of the given bit arrays. This storage order is called transposition.

It may also be advantageous to address one or more of the issues identified above, such as by using optimization of query service to reduce/minimize memory pressure while retrieving data. The query service may be optimized to take as little memory as possible and to require no shared state, so as to make it suitable for implementation as a cloud-native function.

Some of the disclosed embodiments therefore provide methods and systems for indexing and accessing documents over cloud network.

One such embodiment is a method of indexing and searching data and documents over cloud network. Indexing could begin by extracting a sequence or plurality of values from the data or documents. The method may include allocating a bit array of a predetermined size in a memory, and constructing a bloom filter based on the sequence or plurality of values, wherein each of the values is hashed and the value is merged into the bit array. The method may further include determining density of the bloom filter for the series or plurality of values, and iteratively reducing the size of the bit array until the density of the bloom filter is greater than a predetermined density level which may be based on the acceptable error rate for the filter. The resulting bit array can be stored in a storage folder, where generated bit arrays of the same size are grouped together.

This method uses the data or document content itself for building profiles, indexes and linkages, so as to pick up correlations and relations. The method further seeks to reduce the resource, in particular, memory utilization, thereby making the process of data or document search more memory-efficient. This makes search using the method more compatible with cloud-based services. The method may allow building indexes of large tabular data structures and may be organized in such a way that the memory pressure on retrieval is minimal, and that the underlying storage structure is optimized for cloud native services. In other words, the method may make search scalable in a cloud-native landscape.

Another such embodiment is a document accessing device for accessing a plurality of documents. The document accessing device includes a processor and a memory communicatively coupled to the processor, wherein the memory stores processor instructions, which, on execution, causes the processor to extract a series of values from a document or plurality of documents; allocate a bit array of a predetermined size in a memory; construct a bloom filter based on the bit array, wherein each of a plurality of values in the bit array is hashed; determine density of the bloom filter; iteratively tune the bit array until the density of the bloom filter is greater than a predetermined density level; and store the tuned bit array in a storage folder, wherein a plurality of bit arrays of same size are grouped together.

Yet another such embodiment is a non-transitory computer-readable storage medium having stored thereon, a set of computer-executable instructions causing a computer including one or more processors to perform steps that include: extracting a series of values from a document or plurality of documents; allocating a bit array of a predetermined size in a memory; constructing a bloom filter based on the bit array, wherein each of a plurality of values in the bit array is hashed; determining density of the bloom filter; iteratively tuning the bit array until the density of the bloom filter is greater than a predetermined density level; and storing the tuned bit array in a storage folder, wherein a plurality of bit arrays of same size are grouped together.

Yet another such embodiment is a method of reducing/minimizing memory pressure on retrieving data by using hashing. Hashing is a data structure designed to use a special function (called the Hash function) which is used to map a given value with a particular key for faster access of elements. The efficiency of mapping may depend on the efficiency of the hash function used.

Yet another such embodiment is a method of reducing/minimizing memory pressure on retrieving data, by using hash folding. Hash folding may allow for reducing a bit array, and hence pressure on memory usage, by folding last half of the array into the first half of the array and “OR”ing the bits together. If an in-memory bit array of size 1024 (addressable from 0 . . . 1023) is being built, it could be reduced accordingly after the fact, by simply folding the last half of the array into the first half of the array and “OR”ing the bits together. When hashes of a larger size are reduced to a smaller size, bits may be simply sliced off on either side of the hash. In other words, a hash that produces values between 0 and 1024 can be turned into a hash that produces values between 0 and 511 by either dividing the values by two, or by using modulo 512.

Yet another such embodiment is a method of reducing/minimizing memory pressure on retrieving data, by using transposition. When many bit arrays of the same size are given, it is better to put all bits that are in the same position number next to each other, as a single read operation can then retrieve all of the bits at position N over many of the given bit arrays. This storage order is called transposition, as normally the bit position N is the fast-moving axis and the array number A is the slow-moving axis. The bit matrix may be transposed so that the fast-moving axis is the array number A and the bit-position N is the slow-moving parts. This aligns the data structure with the expected retrieval pattern.

Yet another such embodiment is a method of reducing/minimizing memory pressure by optimizing query service. The query service may be optimized to take as little memory as possible and to require no shared state, so as to make it suitable for implementation as a cloud-native function. The query process may be provided a word (or data item) and may return a set of identifiers that point to columns/streams in question. The above exemplary embodiment is a probabilistic search. This probabilistic search may sometimes give a false positive, i.e., may provide an indication about whether a search result is there when there actually is none. This chance may be controlled as a design parameter and can be made arbitrarily small at the cost of more storage. Further, the embodiment may provide an indication where a search result is found, but may not identify the exact location within the document/table, nor may identify how many times it occurs. This may be made more accurate by splitting the tables into pages that are indexed separately, in which case the embodiments may indicate in which page the search result is found. Counting may be implemented by using a different index structure, but that may cost an order of magnitude more storage (˜x32). By optimizing for bulk indexing a full column, the values of a column may be presented to the indexing algorithm in a coherent fashion (in sequence for example). This may be done to minimize the memory usage, so that only that part of the index structure has to reside in memory that is relevant to the column being indexed, after which it is written to colder storage.

The techniques of the above embodiments provide for reducing/minimizing memory pressure on retrieving data. The techniques may use data itself for building profiles, indexes and linkages, so as to pick up correlations and relations. The techniques further seek to reduce the resource, in particular, memory utilization, thereby making the process of document accessing compatible with cloud-based storage. The techniques may allow building indexes of large tabular data structures and organizing in such a way that the memory pressure on retrieval is minimal, and that the underlying storage structure is optimized for cloud native services. In other words, the techniques may make search scalable in a cloud-native landscape.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for accessing a plurality of documents, in accordance with an embodiment.

FIG. 2 is a block diagram of a memory of a document accessing device for accessing a plurality of documents, in accordance with an embodiment.

FIG. 3 is a flowchart of a method of indexing and accessing documents over a cloud network, in accordance with an embodiment.

FIG. 4 is a flowchart of a method for running and executing a search query, in accordance with an embodiment.

FIG. 5 is a flowchart of a method of indexing and accessing documents over a cloud network, in accordance with another embodiment.

FIG. 6 is a flowchart of indexing and accessing documents over a cloud network, in accordance with another embodiment.

FIG. 7 is a flowchart of a method of indexing and accessing documents over a cloud network, in accordance with another embodiment.

FIG. 8 is a flowchart of a method of indexing and accessing documents over a cloud network, in accordance with another embodiment.

FIG. 9 is a flowchart of a method of indexing and accessing documents over a cloud network, in accordance with another embodiment.

FIG. 10 is a schematic block diagram of a data analysis system in accordance with an embodiment of the present invention.

FIG. 11 is a schematic flow chart of a method in accordance with an embodiment of the invention.

FIG. 12 is a schematic flow chart of a method in accordance with an embodiment of the invention.

FIGS. 13a-13c are schematic representations of steps in a method of generating hash lists in accordance with an embodiment of the invention.

FIGS. 14a-14l are schematic representations of steps in a method of generating a matrix, in accordance with an embodiment of the invention.

FIG. 14m shows a process organizing a set of images, in accordance with an embodiment of the invention.

FIG. 15 is a block diagram of an exemplary computer system for implementing various embodiments.

FIG. 16 is a schematic representation of a user interface in accordance with an embodiment of the invention;

FIG. 17 is a schematic representation of a user interface in accordance with an embodiment of the invention;

FIG. 18 is a schematic representation of a user interface in accordance with an embodiment of the invention;

FIG. 19 is a schematic representation of a user interface in accordance with an embodiment of the invention;

FIG. 20 is a schematic representation of a user interface in accordance with an embodiment of the invention;

FIG. 21 is a schematic representation of a user interface in accordance with an embodiment of the invention;

FIG. 22 is a schematic representation of a user interface in accordance with an embodiment of the invention; and

FIG. 23 is a schematic representation of a user interface in accordance with an embodiment of the invention;

FIG. 24 is a schematic flow chart of a method in accordance with an embodiment of the invention;

FIG. 25 is a schematic flow chart of a method in accordance with an embodiment of the invention;

FIG. 26 is a schematic flow chart of a method in accordance with an embodiment of the invention;

FIG. 27 is a schematic block diagram of a data processing system in accordance with an embodiment of the invention; and

FIGS. 28A-28E are schematic representations of a simplified example of determining a score

FIG. 29 is a schematic block diagram of a data visualization system accordance with an embodiment of the present invention;

FIGS. 30A-D are schematic illustrations of the processing of an exemplary set of co-ordinate data to determine a set of split values;

FIG. 31 illustrates an example of a binary tree structure where nodes in the binary tree are associated with split values and leaves are associated with co-ordinate data used to generate the binary tree;

FIG. 32 illustrates the storage of the binary tree of FIG. 3 in the form of a pair of linear arrays;

FIG. 33 is a flow diagram of the processing undertaken to generate a set of split values for converting co-ordinate data into intensity data;

FIG. 34 is a flow diagram of the processing undertaken to determine the number of incidents associated with co-ordinate data within an identified area;

FIG. 35 is a schematic illustration a query area and set of co-ordinates associated with a number of incidents;

FIG. 36 is a schematic illustration of an index and a set of co-ordinate data stored as a binary array; and

FIG. 37 is a schematic illustration of a set of co-ordinate data, an associated data mask and a cumulative index for determining the numbers of incidents associated with a particular area.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

(1) Overview of Various Embodiments

The present application discloses embodiments for accessing indexing and accessing documents over a cloud network. The embodiments provide for building indexes of large tabular data structures and organizing the data in such a way that the memory pressure on retrieval is minimal. As such, these embodiments provide for one or more methods of reducing/minimizing memory pressure on retrieving data, thereby enhancing or optimizing the underlying storage structure enhanced/optimized for cloud native services. The embodiments make use of the various components including hashing, bloom filters, hash folding and bit transpositions, etc., and tuning the composition of these components to suit the system architecture that the cloud native landscapes provide.

(1.1) Hashing

Hashing is a data structure designed to use a special function (called the Hash function) to map a given value with a particular key for faster access of elements. The efficiency of mapping may depend on the efficiency of the hash function used.

(1.2) Bloom Filters

A bloom filter may be an in-memory bit array that acts as a probabilistic data structure to perform set-containment. It responds to queries by indicating either that the item queried has never been seen or that is has probably been seen. The probability of indicating a false positive that the item has been seen is tunable by changing the size of the bit array and thus the density of the bits stored. The bloom filter accommodates larger data sets with a larger bit array which will maintain the probability of a false positive. Bloom filters take a hash of the item to be indexed, and then set a number of bit positions in the bit array to 1, the bit positions are chosen based on the value of the hash. The number of bit positions is tunable and can be chosen optimally to minimize the error rate.

(1.3) Hash Folding

When hashes of a larger size are reduced to a smaller size, bits may be simply sliced off on either side of the hash. In other words, a hash that produces values between 0 and 1024 can be turned into a hash that produces values between 0 and 511 by either dividing the values by two, or by using modulo 512. If an in-memory bit array of size 1024 (addressable from 0 . . . 1023) is being built, it could be reduced accordingly after the fact, by simply folding the last half of the array into the first half of the array and “OR”ing the bits together.

(1.4) Transposition

When many bit arrays of the same size are given, it is better to put all bits that are in the same position number next to each other, as a single read operation can then retrieve all of the bits at position N over many of the given bit arrays. This storage order is called transposition, as normally the bit position N is the fast-moving axis and the array number A is the slow-moving axis. The bit matrix may be transposed so that the fast-moving axis is the array number A and the bit-position N is the slow-moving parts. This aligns the data structure with the expected retrieval pattern.

(1.5) Optimizing of the Query

In some embodiments, query service may be optimized to take as little memory as possible and to require no shared state, so as to make it suitable for implementation as a cloud-native function. The query process may be given a word (or data item) and may return a set of identifiers that point to columns/streams in question.

(2) Exemplary Embodiments to Employ Various Embodiments

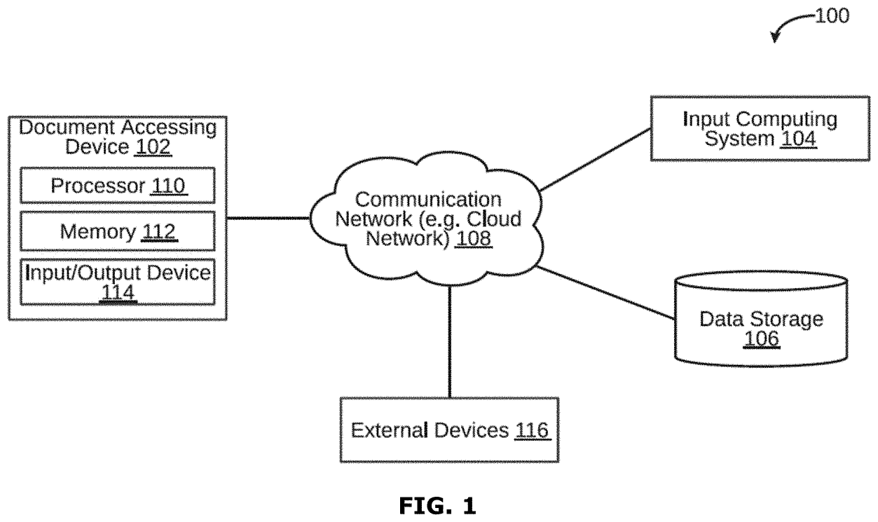

A system 100 for processing and accessing a document is illustrated in FIG. 1, in accordance with an embodiment. The system 100 may include a document accessing device 102, an input computing system 104, and a data storage 106. The document accessing device 102 may be a computing device capable of accessing a plurality of documents. Examples of the document accessing device 102 may include, but are not limited to, server, desktop, laptop, notebook, netbook, tablet, smartphone, mobile phone, application server, sever, or the like.

The document accessing device 102 may access documents, for example in response to a search query. By way of an example, the document accessing device 102 may receive a user request (for example, a search query) via the input computing system 104. To this end, the document accessing device 102 may be communicatively coupled to the input computing system 104 via a communication network 108. The document accessing device 102 may further store a bit array in the data storage 106. To this end, the document accessing device 102 may be communicatively coupled to the data storage 106 via the communication network 108. The communication network 108 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS). In some embodiments, the communication network 108 may be a cloud network.

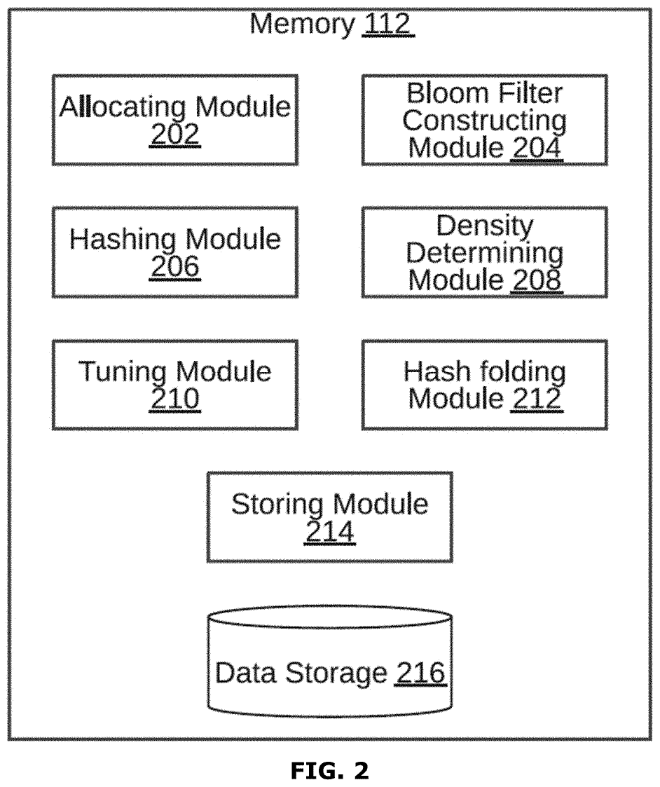

As will be described in greater detail in conjunction with FIG. 2 to FIG. 17, in order to access a plurality of documents, the document accessing device 102 may allocate a bit array of a predetermined size in a memory. The document accessing device 102 may further construct a bloom filter in the bit array, wherein the bloom filter may indicate whether a value is not indexed by the bloom filter or probably indexed by the bloom filter. The document accessing device 102 may further determine density of the bloom filter. The document accessing device 102 may further iteratively tune the bit array until the density of the bloom filter is greater than a predetermined density level based on a chosen probability of a false positive. The document accessing device 102 may further store the tuned bit array in a storage folder; wherein a plurality of bit arrays of same size are grouped together.

In order to perform the above discussed functions, the document accessing device 102 may include a processor 110 and a memory 112. The memory 112 may store instructions that, when executed by the processor 110, may cause the processor 110 to access documents, as discussed in greater detail in FIG. 2 to FIG. 17. The memory 112 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited to Dynamic Random Access Memory (DRAM), and Static Random-Access memory (SRAM). The memory 112 may also store various data (e.g., bit array data, hash data, hash folding data, bloom filter data, etc.) that may be captured, processed, and/or required by the system 100.

The document accessing device 102 may further include a user interface 114 through which the document accessing device 102 may interact with a user and vice versa. By way of an example, the user interface 114 may be used by a user to enter a search query. The user interface 114 may further allow a user to view the search results provided by the document accessing device 102. The system 100 may interact with one or more external devices 116 over the communication network 108 for sending or receiving various data. Examples of the one or more external devices 116 may include, but are not limited to a remote server, a digital device, or another computing system.

(3) Exemplary System for Various Embodiments

Referring now to FIG. 2, a functional block diagram of the memory 112 within the document accessing device 102 configured to access a plurality of documents, in accordance with an embodiment. The memory 112 may include one or more modules that may perform various functions so as to access a plurality of documents. The memory 112 may include an allocating module 202, a bloom filter constructing module 204, a hashing module 206, a density determining module 208, a tuning module 210, a hash folding module 212, a storing module 214, and a data storage 216. As will be appreciated by those skilled in the art, all such aforementioned modules and data storage 202-216 may be represented as a single module or a combination of different modules. Moreover, as will be appreciated by those skilled in the art, each of the modules and data storage 202-216 may reside, in whole or in parts, on one device or multiple devices in communication with each other.

In some embodiments, the allocating module 202 may allocate a bit array of a predetermined size in the memory. The bit array may be allocated of size M. M may be chosen ahead of time to be large enough to accommodate the largest expected variety of data values given the wanted error percentage. All bits may be set to 0.

The bloom filter constructing module 204 may construct a bloom filter in the bit array. The bloom filter constructing module 204 may construct the bloom filter to index each value in the bloom filter. For example, when a value is to be indexed by the bloom filter the bloom filter constructing module 204 first uses the hashing module 206 to hash the value to a particular N-bit number, based on the N-but number the bloom filter constructing module 204 then sets certain bits in the bloom filter bit array. The density determine module 208 may determine density of the bloom filter.

The tuning module 210 may iteratively tune the bit array until the density of the bloom filter is greater than a predetermined density level. The tuning module 210 may further calculate an error rate associated with the bloom filter. The tuning module 210 may then iteratively tune the bit array until the error rate associated with the bloom filter is less than a predetermined error rate. The hash folding module 212 may perform hash folding of the bit array to reduce the size of the bit array. The size of the bit array may be predetermined to accommodate a largest expected variety of data values, based on the predetermined error rate. The storing module 214 may store the tuned bit array in a storage folder. The storage folder may be stored in the data storage 216. It may be noted that the storing module may group together a plurality of bit arrays of same size.

(4) Reducing Memory Pressure on Data Retrieval, by Way of Using Bloom Filters

A bloom filter is an in-memory bit array that acts as a probabilistic data structure to perform set-containment. It responds to queries by telling either that the item queried has never been seen or that is has probably been seen. The probability is tunable by changing the density of the bits stored, thus accommodating larger data sets with a larger bit array which will maintain the chances of a false positive. Bloom filters take a hash of the item to be indexed, and then turn that hash into multiple orthogonal parts, each generating a single bit position. The number of bit positions is tunable and can be chosen optimally to minimize the error rate.

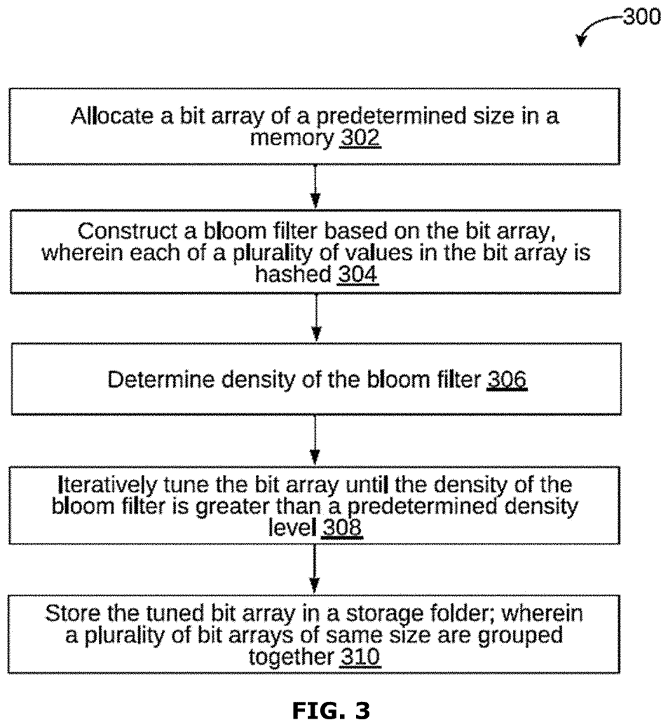

Referring now to FIG. 3, a flowchart 300 of a method of method of indexing and accessing documents over a cloud network is illustrated, in accordance with an embodiment. In some embodiments, the method 300 may be performed by the document accessing device 102 (of system 100, as shown in FIG. 1). The method is described here as working on sequences of data values, which would typically be a column within a database table, but it could also be a sequence of words when indexing textual documents. At step 302, a bit array of a predetermined size may be allocated in a memory. At step 304, a bloom filter may be constructed based on the bit array. At step 306, density of the bloom filter may be determined. At step 308, the bit array may be iteratively tuned until the density of the bloom filter is greater than a predetermined density level. At step 310, the tuned bit array may be stored in a storage folder.

At step 302, a bit array of a predetermined size may be allocated in a memory. The bit array may be of size M. it may be noted that the size M may be chosen ahead of time to be large enough to accommodate the largest expected variety of data values, based on predetermined error percentage. It may be further noted that all the bits may be set to 0.

At step 304, a bloom filter may be constructed based on the bit array. The input values may be read in a streaming fashion. Each value read may be hashed with using a hashing algorithm, turning it into a N-bit number (often 64). This number may be called a Hash Value (HV). In some embodiments, a predetermined number (K) of independent bit positions may be generated by applying a modular reduction function to the hash values with an index parameter. The predetermined number (K) may be a constant number chosen at the same time as M. For example:

BitPos(i):=(i*prime_constant) % M

It may be noted that 1 value may be written at each of the identified locations. If a 1 value is already present at the written location, there may be no changes.

In some embodiments, constructing the bloom filter may further include reading the plurality of input values in a streaming fashion, hashing each of the plurality of input values to generate a plurality of hashed values, and applying a modular reduction function to each of the plurality of hashed values using an index parameter, to generate a predetermined independent bit positions.

At step 306, density of the bloom filter may be determined. Once all values are received, density of the bloom filter may be estimated by counting the bits that are set. It may be noted that based on a required density of the bloom filter which may be sufficient to keep the error rate at the right level, the bit array may be folded down into a smaller size. At step 308, the bit array may be iteratively tuned until the density of the bloom filter is greater than a predetermined density level. The bit array may be folded down in a step-by step manner, wherein each step may reduce the bit array size. For example, the bit array size may be reduced as follows:

NewBit(x)=OldBit(x) OR OldBit(x+M/2),
Where, M is the size of the OldBit array; and
   NewBit will be of size half M.

The above steps may be repeated until the density is sufficiently large.

In some embodiments, an error rate associated with the bloom filter may be calculated. Thereafter, the bit array may be iteratively tuned until the error rate associated with the bloom filter is less than a predetermined error rate. It may be noted that the bit array may be tuned by hash folding the bit array to reduce the size of the bit array. It may be further noted that the size of the bit array may be predetermined to accommodate a largest expected variety of data values, based on the predetermined error rate.

At step 310, the tuned bit array may be stored in a storage folder. In other words, the generated bit array may be written to a storage folder, where it is grouped by resulting size M (after folding), so that all bit arrays of the same size are stored together. It may be prefixed in the filename with an identifier that links it back to the column/datastream. It may be understood that after writing, the memory may be freed. In some embodiments, the bit arrays may be transposed to enable one or more bits at a position to be retrieved together. Thereafter, a plurality of different small input files of same size may be merged into one large input file.

(5) Reducing Memory Pressure on Data Retrieval, by Optimizing the Query

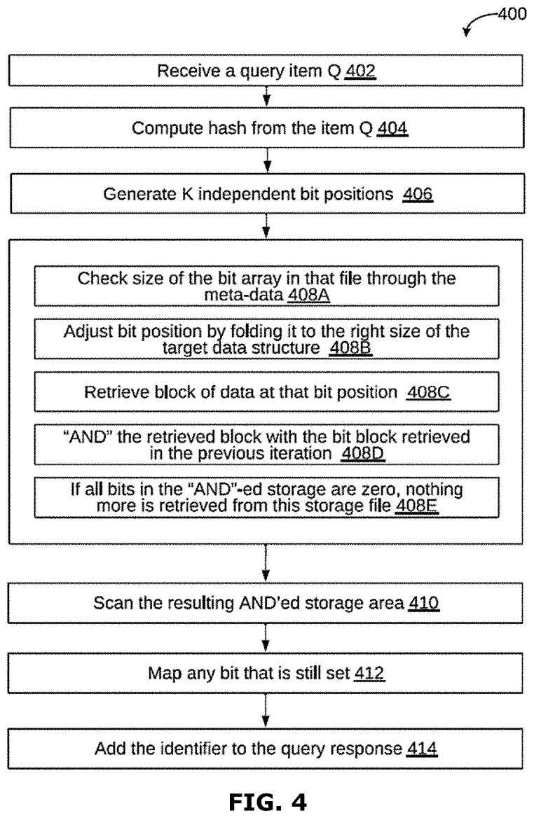

In some embodiments, query service may be optimized to take as little memory as possible and to require no shared state, so as to make it suitable for implementation as a cloud-native function. The query process may be given a word (or data item) and may return a set of identifiers that point to columns/streams in question. The process of running a query is further explained in the conjunction with FIG. 4.

Referring now to FIG. 4, a flowchart 400 of a method of running and executing a search query is illustrated, in accordance with an embodiment. At step 402, a query item Q may be received from a user. At step 404, a hash may be computed from item Q by applying the same hash function as used by the indexer. At step 406, K independent bit positions may be generated (same as the indexer). At step 408A, for each generated bit position, and for each file in the compacted storage folder, size of the bit array may be checked in that file through the meta-data. At step 408B, the bit position may be adjusted by folding it to the right size of the target data structure. At step 408C, a block of data may be retrieved at that bit position (this reads as many bits as there were files compacted into this file). At step 408D, the retrieved block may be “AND” with the bit block retrieved in the previous iteration (previous iteration for the exact same storage file). At step 408E, if all bits in the “AND”-ed storage are zero, nothing more may be retrieved from this storage file (early out).

At step 410, the resulting AND'ed storage area may be scanned for bits that are still set. At step 412, any bit that is still set may be mapped through the metadata to an identifier. At step 414, that identifier may be added to the query response. It may be noted that the query system may be expanded to perform the same query also on non-compacted storage, where it may retrieve the bits directly from the non-pivoted data. This is less efficient, but it eliminates the requirement of the compactor to run when new data is being added.

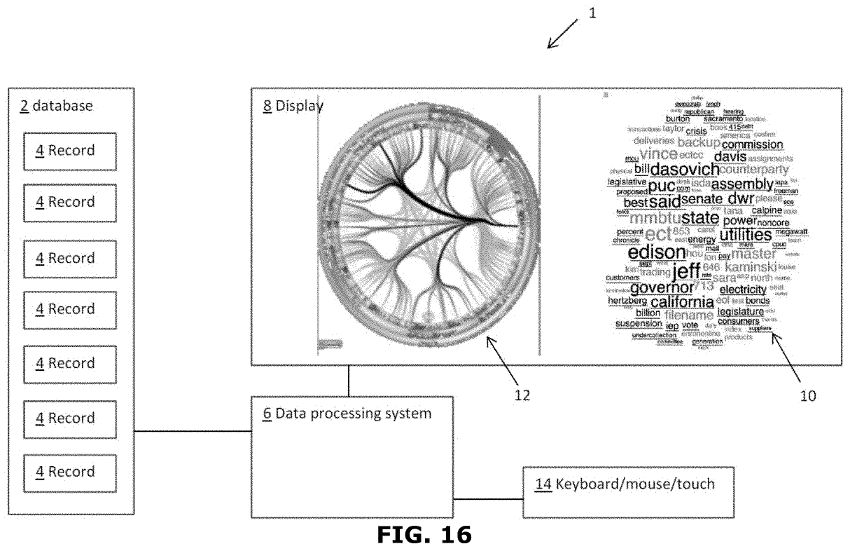

In other embodiments, the query process can be further optimized using a ranked search. FIG. 16 shows a schematic block diagram of a system 1 in accordance with an embodiment of the present invention. The system 1 includes a database 2. The database 2 includes a plurality of records 4. The records can for instance include texts, images, video fragments, audio fragments etc. Each record 4 is associated with one or more items of data. The items of data can e.g. be text items, such as words or phrases, included in the record 4. Words can also be identifiers, names, metadata, dates, flags, tags, derived data, numerical values or bandings, timestamps etc. The items of data can also be images, such as moving images, or fragments thereof. The items of data can also be geographical data, temporal data, connectivity data, etc.

The system 1 further includes a data processing system 6 in communication with the database 2. The system 1 further includes a display 8 in communication with the data processing system 6. The data processing system 6 is arranged for generating data representing a user interface. The user interface is displayed on the display 8. In FIG. 16 the user interface includes a first view 10 including a word cloud of items of data of records 4 of the database 2. In this particular example the records relate to email messages and the word cloud includes items of data in the form of words appearing in the emails as described in U.S. patent application Ser. No. 13/102,648 published as US 2012/284155 incorporated herein by reference. The senders and recipients of the email messages in the database are represented by positions around the edge of the circle and the existence of an email message is shown by the presence of a line connecting the points associated with a sender and the recipient(s). In FIG. 16 the user interface includes a second view 12 including a circular representation of items of data of records 4 of the database 2. In this particular example the circular representation includes items of data in the form of sender-recipient relationships in the emails. The system 1 further includes an input unit, such as a keyboard, mouse and/or touch unit 14 in communication with the data processing system 6.

As will be described below, the user interface, especially the word cloud, allows for highly efficient browsing through the records of the database 2. Also, the user interface provides a transparent and intuitive way of browsing. Further, as will be described below, the user interface assists in refining a query of the database. Thereto, the data processing system can propose items of data that have high discriminative power favoring in-group records that comply with the present query. As will be highlighted below, the data processing system can also propose items of data that have high discriminative power favoring out-group records that do not comply with the present query. Items of data having a high discriminative power favoring in-group records are items of data that have a high likelihood of occurring in an in group record and a low likelihood of occurring in an out group record. Items of data having a high discriminative power favoring out-group records are items of data that have a high likelihood of occurring in an out group record and a low likelihood of occurring in an in group record.

In FIG. 16 the word cloud includes both words having high discriminative power for in-group records and words having high discriminative power for out-group records. It has been found that the user interface including items of data having high discriminative power for in-group records and items of data having high discriminative power for out-group records increases the efficiency of browsing through the database. It, inter alia, provides insight into what has been selected by the present query versus what other information is contained in the database. It can also help identify what information (e.g. which items of data) relate to background information rather than to foreground information that has been selected by the user. Knowledge of background information also aids in quickly focusing a query towards a desired result.

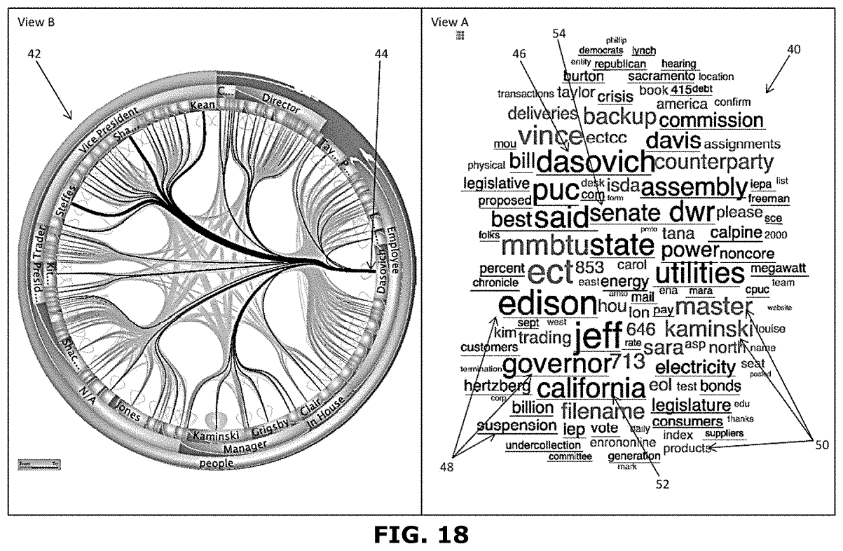

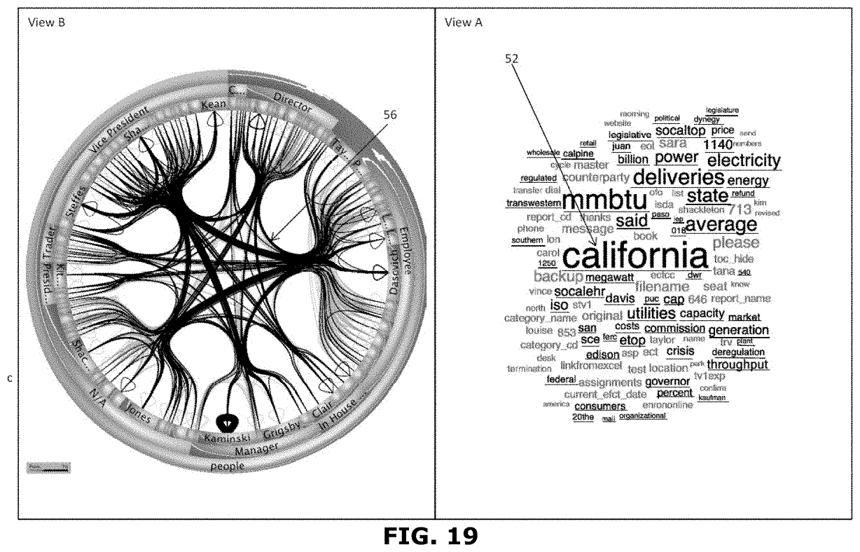

FIG. 18 shows an example of a schematic representation of a data processing system 6 according to the invention. The data processing system 6 is associated with a database 2 storing a set of records. The processing system 6 includes a retrieval unit 20 arranged for retrieving records from the database 2. As will be explained below, the data processing system 6 further includes an identification unit 22 arranged for identifying in each record one or more items of data. A generation unit 24 is arranged for generating a concordance of the items of data identified in the records. The data processing system further includes an assignation unit 26 arranged for assigning each record to a first group of records or to a second group of records. A conversion unit 30 may be included for generating a list of representations, each representation representing a record in the database 2. The data processing system further includes a processing unit 34 arranged for determining for each item of data a first indicator representative of its occurrences in the records of the first group, determining for each item of data a second indicator representative of its occurrences in the records of the second group; and determining for each item of data a score representative of a discriminative power of that item of data on the basis of the first and second indicator of that item of data. The data processing system 6 includes, or is associated with, a memory 28 for storing the concordance and/or the list of representations. The data processing unit further includes an input unit 32 for receiving a user input and an output unit 36 for outputting information towards the user.

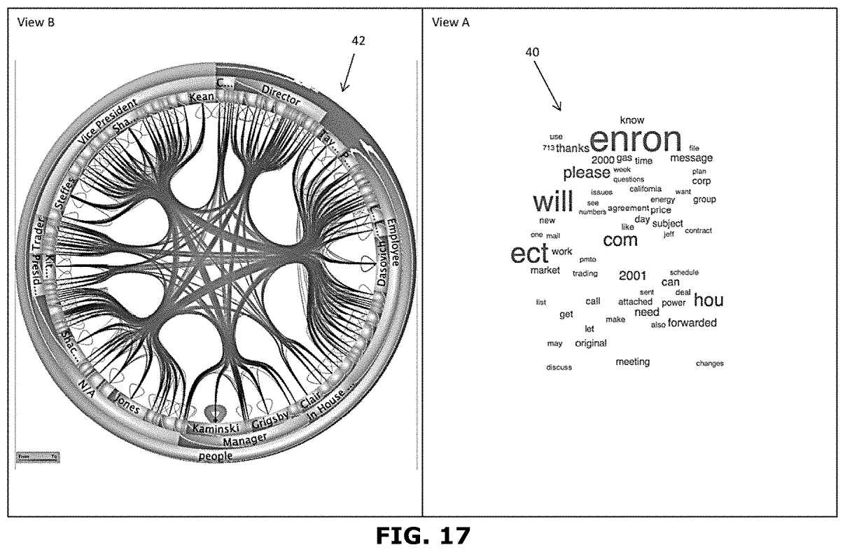

An embodiment of the invention will now be explained in more detail in relation to FIG. 17 and FIG. 18. In this embodiment, the method starts by preprocessing 100 the records 4 contained in the database 2. Thereto, a retrieval unit 20 of the data processing system 6 retrieves 102 all records from the database. In the example mentioned in relation to FIG. 16, the retrieval unit 20 retrieves all email messages from the database 2. FIG. 19A shows a simplified example for four records, each containing a text of a few words. An identification unit 22 identifies 104 items of data included within the records 4. In the example of FIG. 19A the identification unit 22 identifies all unique words within the text data of the records. In this example, the identification unit 22 further assigns 108 a unique identifier to each unique identified item of data. A generation unit 24 then generates a concordance of all unique items of data. The concordance for the simplified example of FIG. 19A is shown in FIG. 19B. The concordance can include the unique identifiers. In this example, the preprocessing 100 also includes generating 114, by a generation unit 24, a list of representations. Each representation represents a record of the database and includes the unique items of data, and/or the corresponding unique identifiers, occurring in that record. FIG. 19C shows the representations of the records of the simplified example of FIG. 19A. In an embodiment, the representation may also include data representative of a prevalence of each occurring item of data within the record.

It will be appreciated that in practice the concordance can be modified for optimizing the concordance for the purpose of browsing the records 4. The concordance may be optimized such that the included items of data represent relevant query items.

Thereto, in step 112, certain items of data may be removed from the concordance. It will be appreciated that for example stop words can be omitted from the concordance. Stop words are words which do not contain important significance to be used in search queries. Common stop words that can be eliminated are “a”, “the”, “is”, “was”, “on”, “which”, etc. It will be appreciated that such stop words are generally known to the person skilled in the art and lists of stop words are readily available. It will also be appreciated that a list of applicable stop words may be dependent on the content of the database.

Also, in step 112 certain items of data can be combined. It will be appreciated that words may be combined, e.g. by stemming or conversion to lower case. Stemming is a process for reducing inflected (or sometimes derived) words to their stem, base or root form. Stemming algorithms are known per se and readily available in the art. Alternatively, or additionally, combining of items of data may be performed by the user, e.g. in a teach mode. Thereto a functionality can be provided in which the user can indicate that certain items of data are to be combined. The functionality can then e.g. assign the same unique identifier to those items of data.

Also, in step 112 certain items of data may be split. It will be appreciated that words may be split, e.g. by disambiguation. Word-sense disambiguation (WSD) is a process of identifying which sense of a word (i.e. meaning) is used in a sentence, when the word has multiple meanings. For instance, the word “bank” can refer to an establishment for monetary transactions as well as to a rising ground bordering a river, depending on the context. The concordance may include a unique entry for each meaning of a word. It will be appreciated that when determining to which meaning an occurrence of such word in a record relates, the context of said word (e.g. words in close proximity to said word) can be taken into account. Splitting of items of data may be performed by the user, e.g. in a teach mode. Thereto a functionality can be provided in which the user can indicate that certain items of data are to be split.

The removing, combining and/or splitting may be executed upon identification of the items of data, upon assigning the unique identifiers, and/or upon generating the concordance. The concordance can be stored in a memory 28 associated with the data processing unit 4, so that the concordance need not be updated or determined again unless the content of the database changes.

Further, in preprocessing 100 a conversion unit 30 of the data processing system 6 converts the records to a list of representations. For each record an associated representation is generated 114. It will be appreciated that the conversion unit 30 may remove duplicates of records. Each representation is a list of items of data, or the associated unique identifiers, that occur in the respective record. If desired the representations may include information on a prevalence of the respective items of data in the respective record. FIG. 19C shows an example of a list of representations for the records of the simplified example of FIG. 19A. The representations can be stored in the memory 28 so that the representations need not be updated or determined again unless the content of the database changes. It will be appreciated that the representations form a much smaller amount of data to be stored than the associated records. The list of representations can be a table, of e.g. integer values, with in rows the individual records and in columns the unique items of data in the concordance (or vice versa).

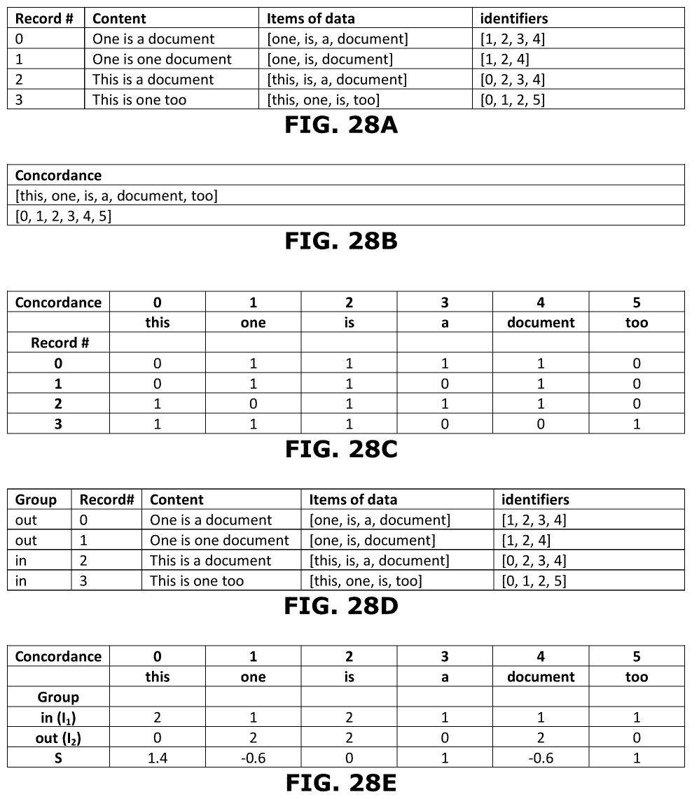

Thus, the preprocessing 100 of the records yields the concordance and the list of representations. The result of preprocessing can be used for generating 116 data representing a user interface representative of the concordance. The data processing system 6 can determine a frequency of occurrence in the combined records of the items of data included in the concordance. Such frequency of occurrence can relate to the total number of occurrences of each item of data. Such frequency of occurrence can also relate to the number of records in which each item of data occurs at least once as in the example of FIG. 28E.

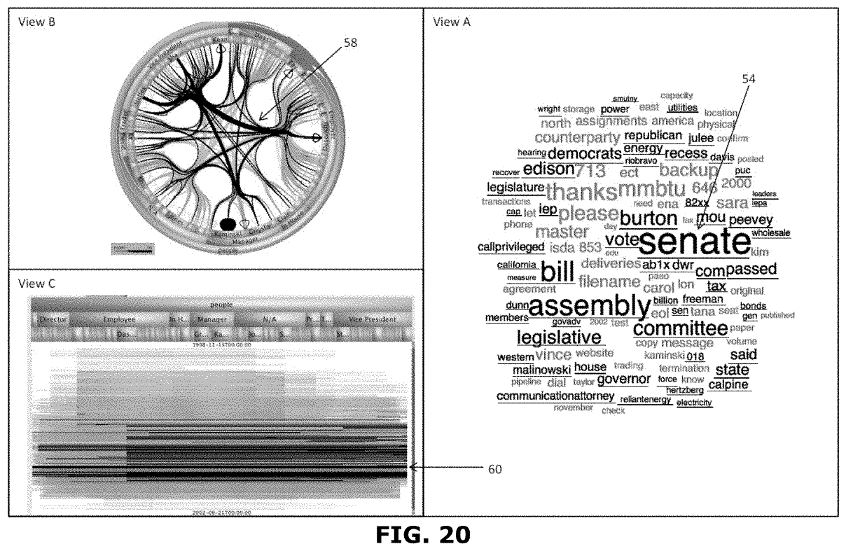

FIG. 20 shows a schematic representation of a generated 116 user interface in relation to preprocessing 100. This example relates to a database 2 including a large number of records 4 in the form of email messages. The email messages contain text. The text includes content, but also sender names, recipient names, addresses, dates, times, flags (“private”, “confidential”, “request read receipt”, etc.). The text can also be included in attachments with text content etc. The text relating to the email message can also be metadata, for instance that that the email message had been marked as junk email, the message has not been read, the message has been recalled, or the like. The records 4 include items of data in the form of words of the texts. In the situation depicted in FIG. 20 preprocessing 100 has been performed. In this example the forty most frequently occurring words are displayed in view A in the form of a word cloud 40. It will be appreciated that stop words have been eliminated in the example of FIG. 20.

In a second view B the user interface displays data representative of the records in a different format. In FIG. 20 view B presents data representative of all records in the database. View B presents data representing the combination of sender and recipient(s) of each email in the database represented as a line in the circular graph. The circumference of the circular graph in view B represents items of data relating to email users (senders and receivers) of the email messages in the database. Interactions between the email users are represented as lines connecting a sender with one or more receivers of the associated email message, as described in WO2012/152726 and US 2014/0132623, both incorporated herein by reference.

Next, a user query 200 may be performed on the database. Thereto a user selects an item of data by means of an input unit 28. The input unit may be a keyboard, mouse, touchpad, touch functionality of a touch screen, microphone, camera or the like. The item of data may be selected 204 from the first view A or may be selected 202 from the second view B. FIG. 20 shows an example of performing a query by selecting 202 an item of data from view B. In the example the selection concerns the emails sent to or from a particular person, indicated in black at 44.

In response to receipt of the user selection, the data processing system 6 processes 206 the user selection. Thereto, the data processing system determines the item of data or items of data associated with the user selection. In this example, the data processing system 6 determines the word, here the name, associated with the sender of the selected stream of email messages. This selection of items of data forms the user query to be performed on the records 4 in the database 2.

For performing the user query, the data processing system 6 starts processing step 300. An assignation unit 26 assigns 302 each record 4 to a first group of records or to a second group of records. Here the first group constitutes an in-group, i.e. a group of records that complies with the user query. Here the in-group contains the records that comprise the selected items(s) of data, i.e. the name of the sender. It will be appreciated that it is not necessary that all records indicate the selected item of data as the sender of that particular email message. Also records containing the selected item of data as recipient, or as part of the content of the email message, will form part of the in-group. Here the second group constitutes an out-group, i.e. a group of records that does not comply with the user query. Here the out-group contains the records that do not comprise the selected items(s) of data. FIG. 28D shows how the records of the simplified example of FIG. 20A are assigned to an in-group and an out-group in response to a fictional query relating to the word “this”.

Next, a processing unit 34 of the data processing system 6 determines 304, 306 for each item of data a first indicator and a second indicator. The first indicator is representative of the occurrences of the respective item of data in the records of the first group. In an embodiment the processing unit takes the representations of the records in the first group and for each item of data sums the occurrences of that item of data, or the unique identifier thereof, in the representations of the records in the first group. This sum then can be the first indicator. If the representations include a prevalence, this prevalence can be taken into account when determining the first indicator. The second indicator is representative of the occurrences of the respective item of data in the records of the second group. In an embodiment the processing unit takes the representations of the records in the second group and for each item of data sums the occurrences of that item of data, or the unique identifier thereof, in the representations of the records in the second group. This sum then can be the second indicator. If the representations include a prevalence, this prevalence can be taken into account when determining the second indicator. FIG. 28E shows the determination of the first indicator I1 and the second indicator I2 for each item of data by summing the occurrences (“0” or “1”) of that item of data for records 2 and 3 (first group/in-group) and for records 1 and 2 (second group/out-group) in the list of representations respectively. As the processing unit can take the representations of the records and for each item of data sums the occurrences of that item of data, or the unique identifier thereof, in the first and second group of records, the processing for determining the first and second indicator can be (NR-2) simple additions of e.g. integer values, with NR being the number of records in the database. For the entire database only NI sets of first and second indicators need to be determined, with NI being the number of items of data in the concordance. Therefore, the amount of processing for the entire database is extremely limited, the bulk of heavy calculation being done in preprocessing. This makes the process highly suitable for handling big data. With the first indicator and the second indicator, the processing unit 34 can determine 308 for each item of data a score S representative of a discriminative power of that item of data. The score S can be representative of the discriminative power of the item of data for the first or second group of records. A high discriminative power for records of the first group indicates an item of data having a high likelihood of occurring in a record of the first group and a low likelihood of occurring in a record of the second group. A high discriminative power for records of the second group indicates an item of data having a high likelihood of occurring in a record of the second group and a low likelihood of occurring in a record of the first group. The score S can, in addition, also be representative of a prevalence of the item of data in the first group or in the second group. It will be appreciated that an item of data that occurs very few times in the records, may have a high likelihood of occurring more often in one of the two groups, but due to its low prevalence still can have a low discriminative power with respect to that group as a whole. Therefore, in an embodiment the score S takes prevalence into account as well. In an embodiment the highest scores are associated with items of data that have the highest discriminative power for records of the first group and the lowest (or largest negative) scores are associated with items of data that have the highest discriminative power for records of the second group. In the example of FIG. 28E the scores are calculated using the formula S=(I1^{1.5}−I2^{1.5})/(I1+I2). This formula yields an increased positive or negative score for items of data having both a higher likelihood of occurring in one of the two groups and having a higher prevalence. More in general, other formulae can be used as well. The score S can, e.g., be calculated as S=(I1 N−I2 N)/(I1+I2 )M, wherein 11 is the first score, 12 is the second score, N is a parameter between ⅓ and 3 and M is a parameter between ⅓ and 3. Optionally, N is between 1 and 2. Optionally M is between 0.5 and 1. The score can also be calculated as S=(I1 N−I2 N)/(I1 M+I2 M), S=(I1−I2)N/(I1+I2 )M, or S=(I1−I2)N/(I1+I2)M. The best formula for calculating the score S can depend on the nature of the data stored in the database.

When the scores for all items of data have been determined, the processing unit 34 determines 310 a first plurality (e.g. a predetermined number) items of data having the highest discriminative power for records of the first group and determines 312 a second plurality (e.g. a predetermined number) of items of data having the highest discriminative power for records of the second group. In the present example the first plurality of items of data includes the items of data having the highest scores. In the present example the second plurality of items of data includes the items of data having the lowest (most negative) scores. The processing unit 34 may sort the items of data according to their scores for this.

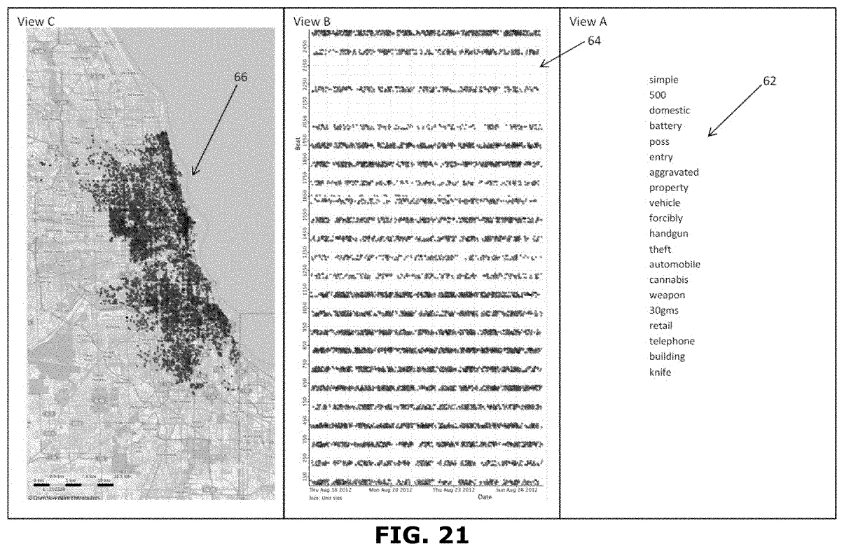

Thus, the processing 300 yields the first and second plurality of items of data. The result of processing can be used for generating data representing a user interface representative of the first and second plurality of items of data. This can be done in step 400 for updating the views A and B. In FIG. 21 the first view A shows the first plurality 48 of items of data, here the top forty words (underlined), and the second plurality 50 of items of data, here the bottom forty words (not underlined). The first and second plurality are visualized as a word cloud 40. It will be appreciated that the selected item of data (selected at 44 in view B of FIG. 21) is also among the first plurality of items of data as indicated at 46, viz. the word (name) “dasovich”. It will be appreciated that the word cloud 40 can be constructed to provide an indication of the score. In this example a font size of the items of data (words) in the word clouds is scaled according to the absolute value of the score S associated with the respective item of data. It is also possible the word cloud 40 can be constructed to provide an indication of an average distance between two items of data of one group within the texts of the records of that group. In this example a distance in between two items of data (words) in the word clouds is scaled according to an average distance between said two items of data within the corresponding records.

FIG. 21 showed a user selection in the second view B resulting in a word cloud 40 containing items of data from the in-group as well as items of data from the out-group. It is noted that due to the use of the concordance and list of representations the inventors have succeeded in providing real-time updating of the first view A in response to a user selection in the second view B.

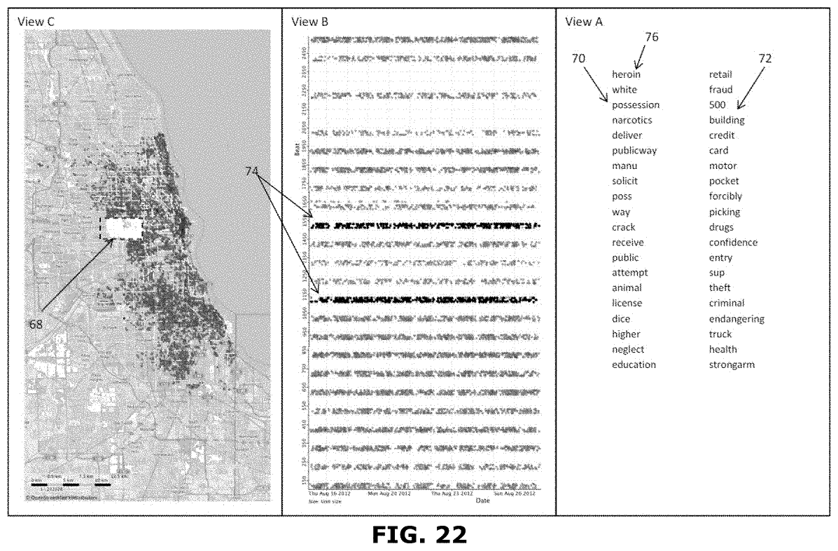

It is also possible to select an item of data in the first view A. FIG. 22 shows an example of a user interface when in the first view A of FIG. 21 the item of data “california” is selected at 52. Similarly, as described above, the assignation unit 26 assigns 302 each record 4 to a first group of records or to a second group of records. Here the first group constitutes the in-group, i.e. the group of records including the word “california”. Here the second group constitutes the out-group, i.e. the group of records not including the word “california”. With the records re-assigned to the first and second groups, the first indicator I1, the second indicator I2, and the score S for each item of data can be determined. It will be appreciated that the concordance and the list of representations need not be determined anew, saving valuable processing time. With the recalculated scores for each item of data, the first plurality of items of data and the second plurality of items of data can be determined anew. FIG. 22 shows in the first view A, a word cloud including these redetermined first and second pluralities of items of data. Simultaneously, the second view B is updated. The selected item of data “california” is used to determine all email messages including the word “california”. The graphical representation of these email messages is shown in black at 56 in the second view B of FIG. 22 in accordance with US 2014/0132623, incorporated herein by reference.

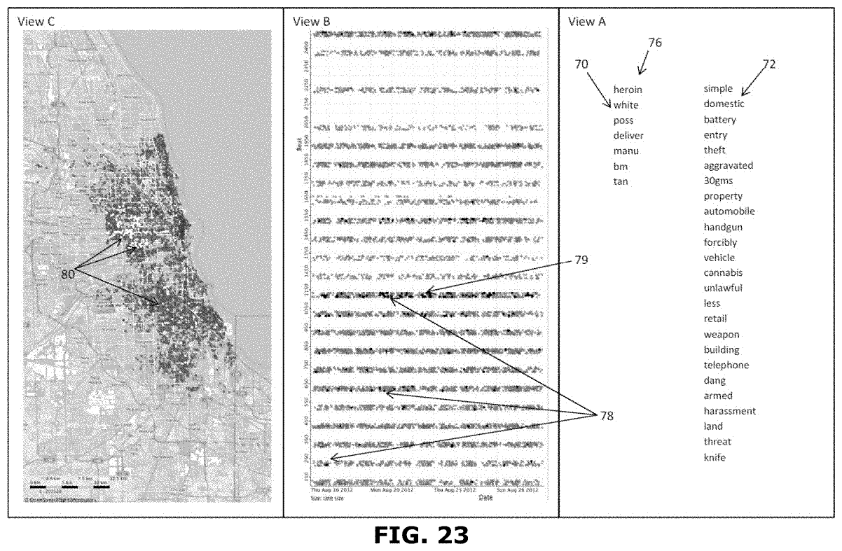

FIG. 23 shows an example of a user interface when in the first view A of FIG. 21 the item of data “senate” is selected at 54. Similar as explained in relation to FIG. 22 the first view A is updated due to the selection of the item of data “senate”. Similarly, the second view B is updated in accordance with US 2014/0132623. The update indicates the records including “senate” in black at 58. The example of FIG. 23 includes a third view C. In this third view C the user interface displays data representative of the records in yet a different format. In FIG. 23 view C presents data representative of a distribution of email messages as a function of time. In horizontal direction the sender-recipient interactions of the records are shown. Horizontal lines represent connections from a sender to a recipient for the records in the database. The senders and recipients are indicated at the top of the graph. In the vertical direction it is indicated at which moment in time the email message was sent. View C is updated in view of the selected item of data “senate” as described in US 2014/0059456, incorporated herein by reference. The update indicates the records including “senate” in black at 60.

It will be appreciated that, in the example of FIGS. 21-23, the multiple views, and the possibility to select items of data for querying the database provides highly useful possibilities for interactively querying the database. It is for example possible to select a word, such as “california” as shown above and instantaneously see the email paths (sender-recipient) that have a high occurrence of said word, and simultaneously and instantaneously see the temporal changes in the occurrence of the word in the records. From this the user can continue by selecting the email paths just indicated as relevant in view of “california” occurring in the records, and see in the first view words related to these email paths. This may initiate a query based on another word than “california”. Alternatively, the user could continue by selecting a time slot indicated as relevant in view of “california” occurring in the records, and see in the first view words related to this time slot. This may initiate a query based on yet another word than “california”. Also, the first view provides insight in other words that have a high discriminative power for records including the word “california”, which can be selected for further querying. Further, the first view provides insight in other words that have a high discriminative power for records not including the word “california”. These too may be used as user selection for further querying. As such, the invention fuses analytics and search. It has been found that in queries that are aimed at uncovering hard-to-find information the out-group information can be particularly useful in arriving at query items that lead to the desired results. Moreover, as will be appreciated from the above, the entire querying can be performed without typing a single word. This is very useful in preventing writer's block from keeping a user from querying the database.

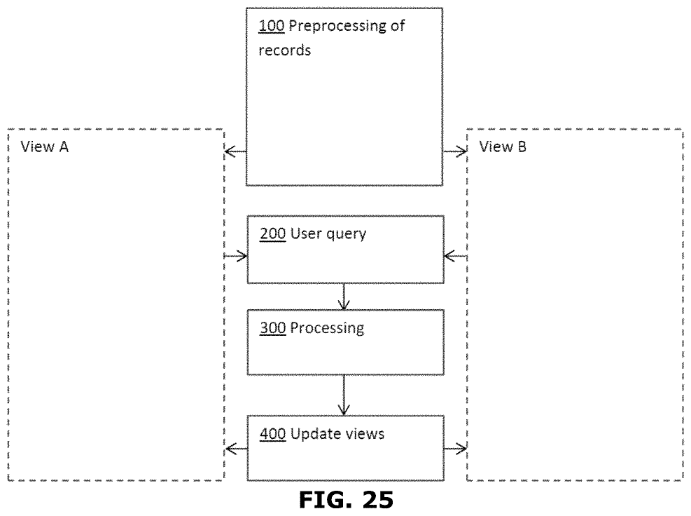

FIGS. 25-27 relate to a further example. FIG. 25 shows a schematic representation of a generated 116 user interface in relation to preprocessing 100. This example relates to a database 2 including a large number of records 4 in the form of police reports. The police reports contain text. The text includes content, but also police officer identification, names, addresses, dates, times, etc. The records 4 include items of data in the form of words of the texts. In the situation depicted in FIG. 25 preprocessing 100 has been performed. Thus, the concordance and the list of representations is determined as described above. In this example the twenty most frequently occurring words are displayed in view A in the form of a list 62 of words. In this example the list 62 is an ordered list. The most frequently occurring item of data is here positioned at the top of the list, the next most frequently occurring item of data at the next position, and so on. It will be appreciated that stop words have been eliminated in the example of FIG. 25.

In a second view B the user interface displays data 64 representative of the records in a different format. In FIG. 25 view B presents data 64 representative of a distribution of police reports as a function of time. It will be appreciated that the records thereto include items of data relating to time. In vertical direction a numerical index of the records is shown. In this example the numerical index is representative of a police route corresponding to the report. In the horizontal direction it is indicated at which moment in time the police report was filed.

In a third view C the user interface displays data 66 representative of the records in yet a different format. In FIG. 25 view C presents data 66 representative of all records in the database. In this example the records include data representative of a geographical location. View C presents data representing for each record in the database the geographical location associated with that record represented as a dot on a representation of a map as described in U.S. patent application Ser. No. 14/215,238, incorporated herein by reference.

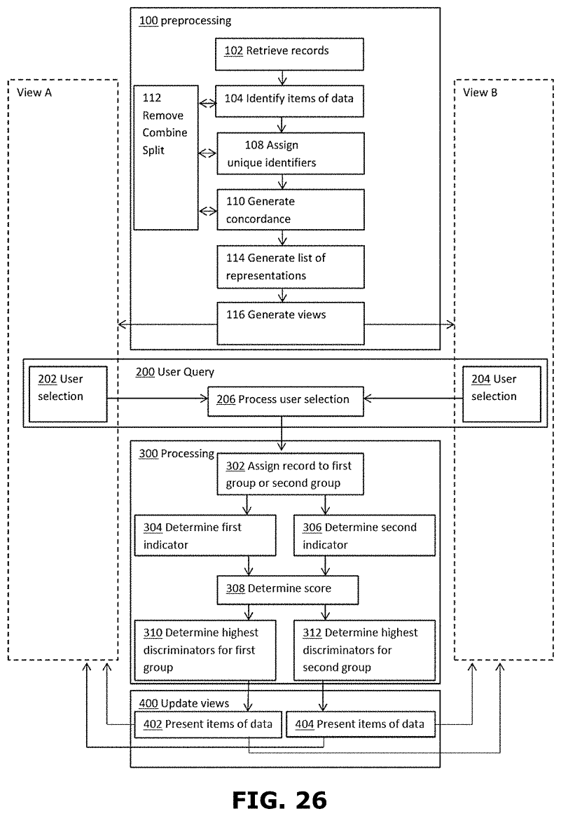

Next, a user query 200 may be performed on the database. Thereto a user selects an item of data by means of an input unit 28. The item of data may be selected 204 from the first view A, the second view B or the third view C. FIG. 26 shows an example of performing a query by selecting an item of data from view C. In the example the selection concerns a geographical area indicated at 68. The geographical area is selected by selecting an area in the representation of the map. The area can e.g. be selected by drawing a contour, such as a rectangle, e.g. by using the mouse.

In response to receipt of the user selection, the data processing system 6 processes 206 the user selection. Thereto, the data processing system determines the items of data associated with the user selection. In this example, the data processing system 6 determines the geographical indicators associated with the police reports having a geographical indicator that falls within the selected area. This selection of items of data forms the user query to be performed on the records 4 in the database 2.

For performing the user query, the data processing system 6 starts processing step 300. The assignation unit 26 assigns 302 each record 4 of the database 2 to a first group of records or to a second group of records. Here the first group constitutes an in-group, i.e. the records that include the selected items(s) of data, i.e. the geographical indicator corresponding to the selected area. Here the second group constitutes an out-group, i.e. the records that do not include the selected items(s) of data, i.e. the geographical indicator corresponding to the selected area.

With the records assigned to the first and second groups, the first indicator I1, the second indicator I2, and the score S for each item of data can be determined as described above. It will be appreciated that the concordance and the list of representations need not be determined anew, saving valuable processing time. FIG. 26 shows in the first view A, a first list 70 of items of data representative of the first plurality of items of data. FIG. 26 shows in the first view A, a second list 72 of items of data representative of the second plurality of items of data. The first and second lists are ordered lists in this example.

Simultaneously, the second view B is updated. The selected items of data determine all records associated with the police reports having a geographical indicator that falls within the selected area. The graphical representation of these police reports as black dots at 74 in the second view B of FIG. 26. In this example the numerical indexes of the records associated with the selected geographical area are mainly in the range of 1100-1150 and 1500-1550. These numerical indexes correspond to police routes within the selected geographical area.

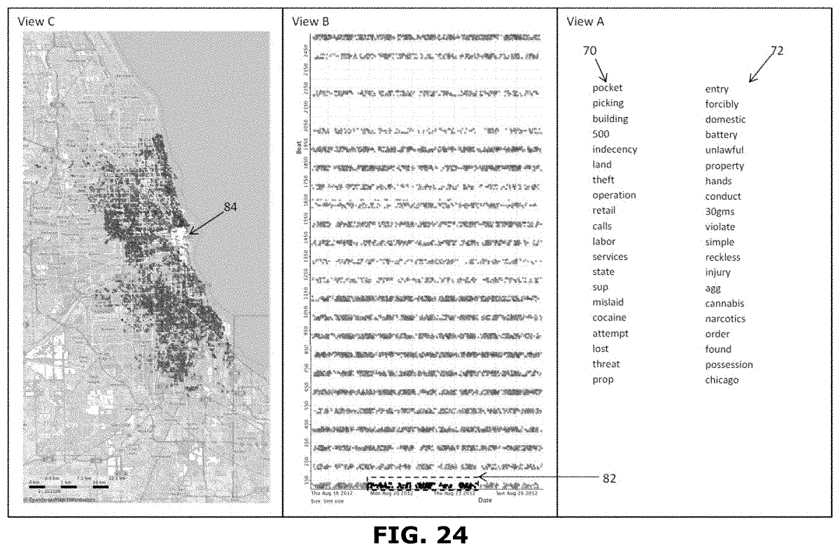

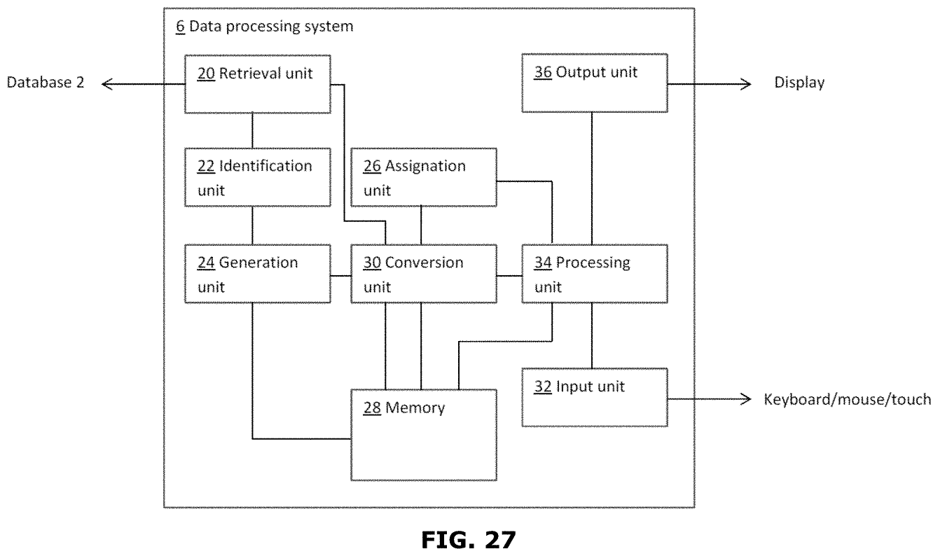

It is also possible to select an item of data in the first view A. FIG. 27 shows an example of a user interface when in the first view A of FIG. 25 or FIG. 26 the item of data “heroin” is selected at 76 from the first list 70. Similarly, as described above, the assignation unit 26 assigns 302 each record 4 to a first group of records or to a second group of records. Here the first group constitutes the in-group, i.e. the group of records including the word “heroin”. Here the second group constitutes the out-group, i.e. the group of records not including the word “heroin”. With the records re-assigned to the first and second groups, the first indicator I1, the second indicator I2, and the score S for each item of data can be determined. It will be appreciated that the concordance and the list of representations need not be determined anew, saving valuable processing time. With the recalculated scores for each item of data, the first plurality of items of data and the second plurality of items of data can be determined anew. FIG. 24 shows in the first view A the first list 70 of words according to the redetermined first plurality of items of data. FIG. 24 shows in the first view A the second list 72 of words according to the redetermined second plurality of items of data. In this example the first list 70 contains fewer items of data than the second list.

Simultaneously, the second view B is updated. The selected item of data “heroin” is used to determine all records including the word “heroin”. The records associated with the police reports including the word “heroin” are indicated as black dots at 78 in the second view B of FIG. 24. It will be appreciated that in this example the records including the item of data “heroin” are spread out over many numerical indexes and spread out in time. However, it is for instance possible to see temporal effects in the occurrence of the word “heroin” in the records. At 79 for example a temporal increase of the occurrence of the word “heroin” in the records can be observed.

Simultaneously, the third view C is updated. The selected item of data “heroin” is used to determine all records including the word “heroin”. The records associated with the police reports including the word “heroin” are indicated as white dots at 80 in the third view C of FIG. 24. It will be appreciated that in this example the records including the item of data “heroin” are spread out over a large geographical range.

It is also possible to select an item of data in the second view B. FIG. 28 shows an example of a user interface when in the second view B of FIG. 25, FIG. 26, or FIG. 24 a range 82 of numerical indexes in the range of 100-150 in a certain time period is selected. In response to receipt of the user selection, the data processing system 6 processes 206 the user selection. Thereto, the data processing system determines the items of data associated with the user selection. In this example, the data processing system 6 determines the numerical indexes and time stamps associated with the police reports within the selection. This selection of items of data forms the user query to be performed on the records 4 in the database 2.

For performing the user query, the data processing system 6 starts processing step 300. The assignation unit 26 assigns 302 each record 4 of the database 2 to a first group of records or to a second group of records. Here the first group constitutes an in-group, i.e. the records that include a numerical index and time stamp associated with the police reports within the selection. Here the second group constitutes an out-group, i.e. the records that do not include the selected items(s) of data, i.e., do not include both a numerical index and time stamp associated with the police reports within the selection.

With the records assigned to the first and second groups, the first indicator I1, the second indicator I2, and the score S for each item of data can be determined as described above. It will be appreciated that the concordance and the list of representations need not be determined anew, saving valuable processing time. FIG. 28 shows in the first view A, a first list 70 of items of data representative of the first plurality of items of data. FIG. 28 shows in the first view A, a second list 72 of items of data representative of the second plurality of items of data. The first and second lists are ordered lists in this example.

Simultaneously, the third view C is updated. The selected items of data, i.e. the numerical indexes and time stamps within the selection are used to determine all records including a numerical index and time stamp within the selection. These records are indicated as white dots at 84 in the third view C of FIG. 28. It will be appreciated that in this example the records including a numerical index and time stamp within the selection are concentrated in downtown Chicago.

It will be appreciated that in the example of FIGS. 25-28 the multiple views, and the possibility to select items of data for querying the database provides highly useful possibilities for interactively querying the database. It is for example possible to select a word, such as “heroin” as shown above and immediately see the geographical areas that have a high occurrence of said word, and simultaneously see the temporal changes in the occurrence of the word in the records. From this the user can continue by selecting the geographical area just indicated as relevant in view of “heroin” occurring in the records, and see in the first view words related to this geographical area. This may initiate a query based on another word than “heroin”. Alternatively, the user could continue by selecting a time slot indicated as relevant in view of “heroin” occurring in the records, and see in the first view words related to this time slot. This may initiate a query based on yet another word than “heroin”. Also, the first view provides insight in other words that have a high discriminative power for records including the word “heroin”, which can be selected for further querying. Further, the first view provides insight in other words that have a high discriminative power for records not including the word “heroin”. These too may be used as user selection for further querying. U.S. Pat. No. 9,824,160

(6) Reducing Memory Pressure on Data Retrieval, by Way of Using Hash Folding

When hashes of a larger size are reduced to a smaller size, bits may be simply sliced off on either side of the hash. In other words, a hash that produces values between 0 and 1024 can be turned into a hash that produces values between 0 and 511 by either dividing the values by two, or by using modulo 512. If an in-memory bit array of size 1024 (addressable from 0 . . . 1023) is being built, it could be reduced accordingly after the fact, by simply folding the last half of the array into the first half of the array and “OR”ing the bits together.

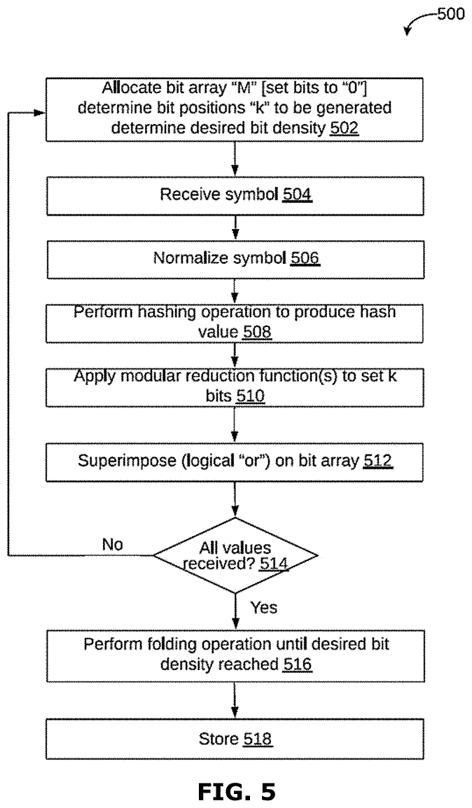

Referring now to FIG. 5, a flowchart 500 a method of indexing and accessing documents over a cloud network is illustrated, in accordance with an embodiment. At step 502, a bit array of a predetermined size “M” may be allocated in a memory. All bits may be set to 0. Further, bit positions “k” to be generated may be determined. At step 504, a symbol may be received. At step 506, the symbol may be normalized. At step 508, hashing operation may be performed to produce hash values. At step 510, modular reduction function(s) may be applied to set “k” bits. At step 512, logical “OR” may be superimposed on the bit array. At

step 514, a check may be performed, to check if all the values have been received. If all the values been received, the method may proceed to step 516 (“Yes” path). At step 516, folding operation may be performed until desired bit density is reached. In other words, the bit array may be tuned, until desired bit density is reached. At step 518, the tuned bit array may be saved in a folder. However, if at step 514, all the values have not been received, the method may proceed once again to step 502 (“No” path), and the process may be repeated.

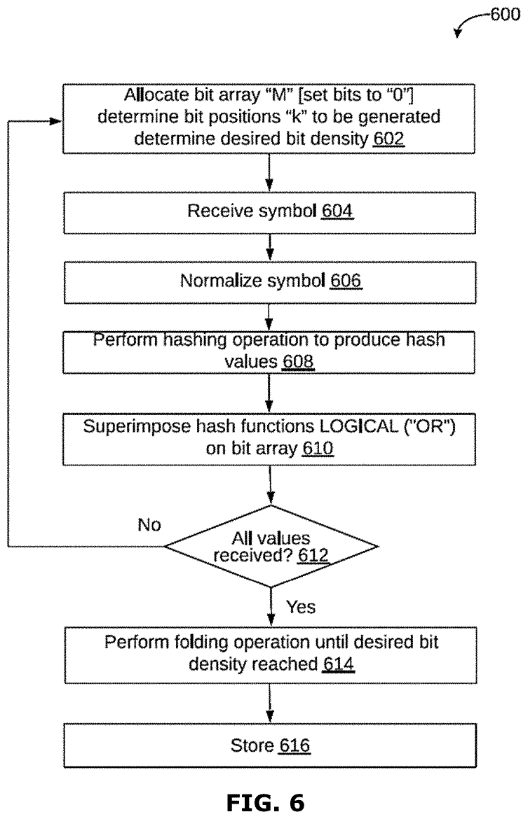

Referring now to FIG. 6, a flowchart 600 of a method of indexing and accessing documents over a cloud network is illustrated, in accordance with another embodiment. At step 602, a bit array of a predetermined size “M” may be allocated in a memory. All bits may be set to 0. Further, bit positions “k” to be generated may be determined. At step 604, a symbol may be received. At step 606, the symbol may be normalized. At step 608, hashing operation may be performed to produce hash values. At step 610, logical “OR” may be superimposed on the bit array. At step 612, a check may be performed, to check if all the values have been received. If all the values been received, the method may proceed to step 614 (“Yes” path). At step 614, folding operation may be performed until desired bit density is reached. In other words, the bit array may be tuned, until desired bit density is reached. At step 616, the tuned bit array may be saved in a folder. However, if at step 612, all the value haves not been received, the method may proceed once again to step 602 (“No” path), and the process may be repeated.

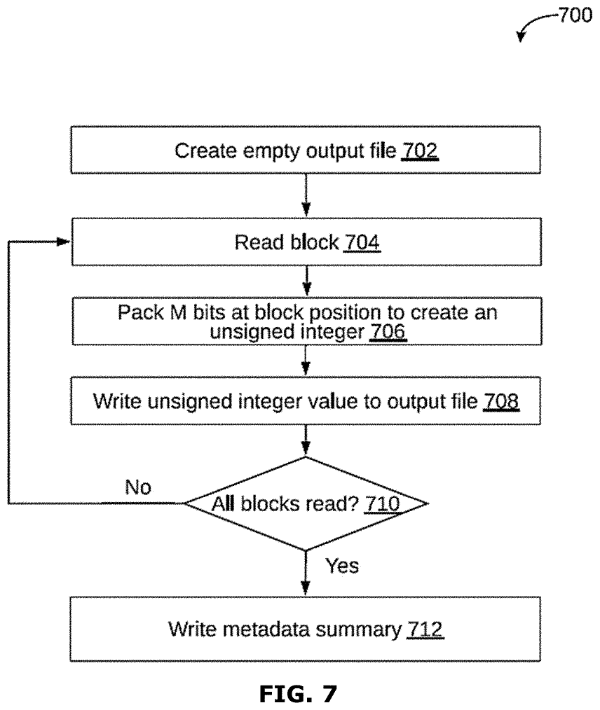

Referring now to FIG. 7, a flowchart 700 of a method of indexing and accessing documents over a cloud network is illustrated, in accordance with another embodiment. At step 702, an empty output file may be created. At step 704, a block may read. At step 706, “M” bits may be packed at block position to create an unsigned integer. At step 708, unsigned integer value may be written to output file. At step 710, a check may be performed to check if all the blocks have been read. If all the block haves been read, the method proceeds to step 712 (“Yes” path). At step 712, metadata summary may be written. However, if at step 710, all the blocks have not been read, the method may proceed once again to step 704 (“No” path), and the process may be repeated.

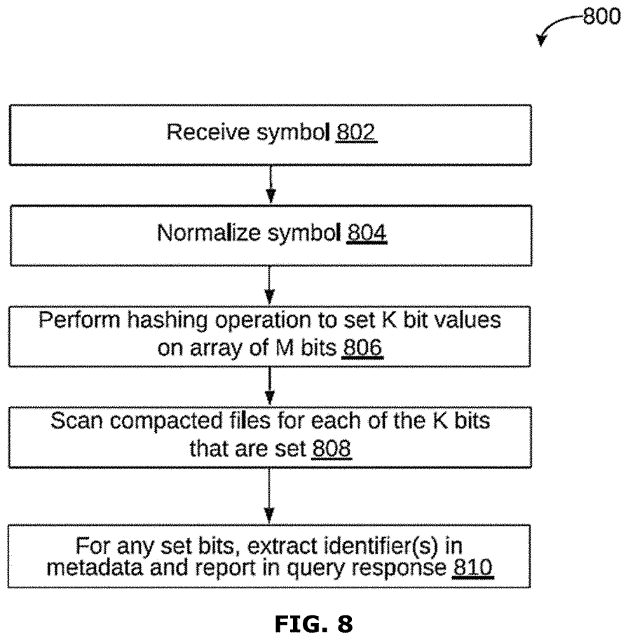

Referring now to FIG. 8, a flowchart 800 of a method of indexing and accessing documents over a cloud network is illustrated, in accordance with another embodiment. At step 802, a symbol may be received. At step 804, the symbol may be normalized. At step 806, hashing operation may be performed to produce hash values. At step 808, compacted files for each of the “k” bits that are set may be scanned. At step 810, for any set bits, identifier(s) in metadata may be extracted and reported in query response.

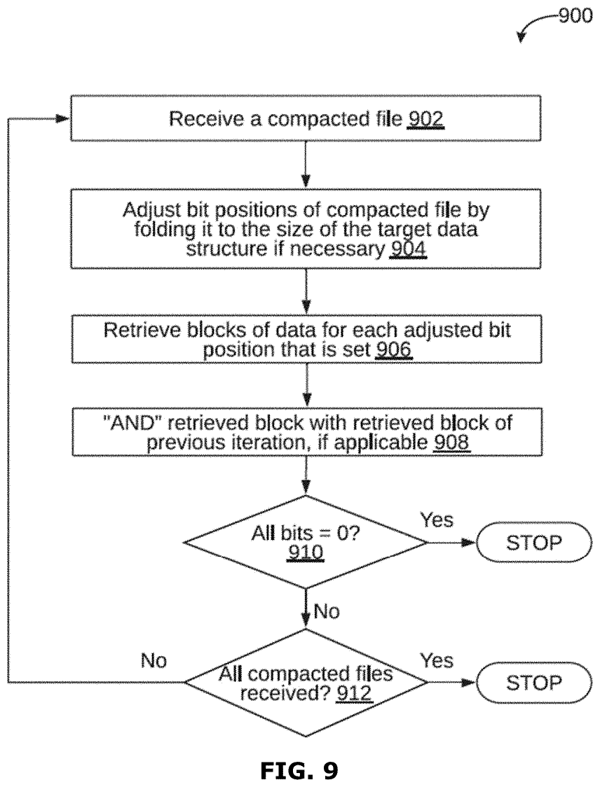

Referring now to FIG. 9, a flowchart 900 of a method of indexing and accessing documents over a cloud network is illustrated, in accordance with another embodiment. At step 902, a compacted file may be received. At step 904, bit positions of compacted file may be adjusted by folding it to the size of the target data structure, if necessary. At step 906, blocks of data may be retrieved for each adjusted bit position that is set. At step 908, retrieved block may be “AND”ed with retrieved block of previous iteration, if applicable. At step 910, a check may be performed to determine if the condition all bits=0 is met. If all the bits=0 condition is met (“Yes” path), then the method may stop. However, if all the bits=0 condition is not met (“No” path), the method may proceed to step 912. At step 912, a check may be performed to determine if all compacted files have been received. If all compacted files have been received (“Yes” path), the method may stop. However, if all compacted files have not been received, (“No” path), the method may proceed once again to step 902, and the process may be repeated.

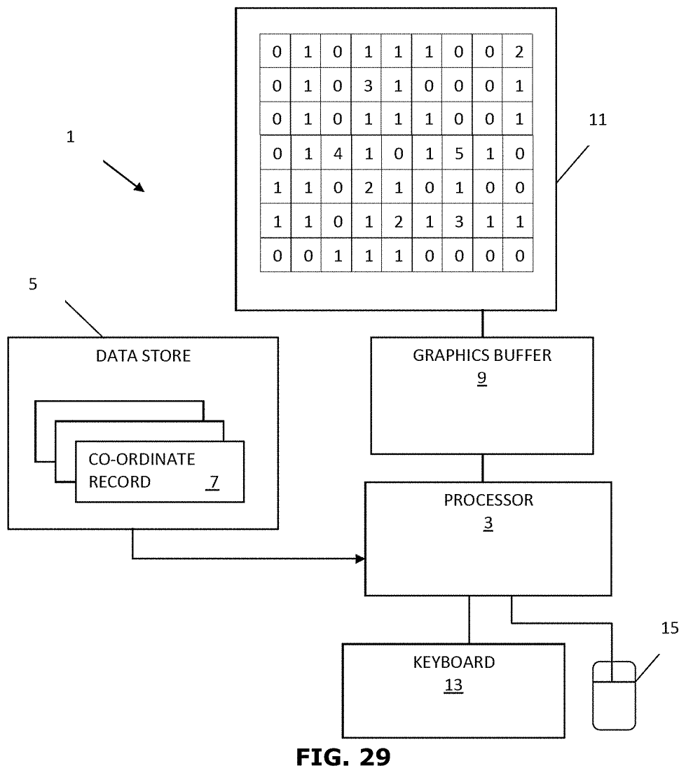

Referring now to FIG. 29 a flowchart 2800 of a method of visualizing data is illustrated, in accordance with another embodiment. FIG. 29 illustrates an exemplary illustration of a data visualization generated by the system 1 on the display 11 in which the generated display data takes the form of an array of numbers where each of the individual cells/entries in the array identifies the number of incidents/co-ordinate records whose co-ordinate data falls/is located within an area that the individual cells of the array are intended to represent. As an alternative example, the generated display could be an array of cells where each individual cell in the array is assigned a color that represents the numbers of incidents with co-ordinate data within the area that each of the cells of the array are intended to represent (i.e. a heat map). In either the case, each of the cells in such an array could correspond to a group of one or more pixels of a display unit.

As will be explained in detail later, in this embodiment, in order to generate a visualization of a number of co-ordinate records that represents the co-ordinate records as an intensity/density map, the system processes the co-ordinate records 7 in the data store 5 to generate data representing an ordering of the co-ordinate records 7 and an associated set of split values which is stored as a linear array. This data represents the co-ordinate records as a linearized binary tree space-partitioning data structure.

In such a representation the root node can be thought of as representing the entire data space. The individual leaf nodes correspond to the individual co-ordinate points identified by the co-ordinate records. Every branch node (i.e. internal node) can be thought of as representing a splitting plane that divides the space into two-parts, referred to as subspaces. Each branch node therefore has a left and a right sub-tree (that corresponds to a subspace), with points to the left of the splitting plane being located on the left sub-tree of that node and points to the right of the splitting plane being located on the right sub-tree.

As will be explained this tree structure is constructed using a canonical method in which the splitting planes are axis-oriented, with their orientation cycling with each level of recursion. In other words, a first dimension is chosen for partitioning at the root level of the tree, with a second dimension being chosen for partitioning at the next level and so on, cycling through the dimensions. Consequently, for a two-dimensional tree, this would typically mean that at level 0 the tree splits on the x-axis, at level 1 on the y-axis, and at level 2 on the x-axis again.

In addition, when constructing the tree structure, each splitting location is chosen to be at the median of the points sorted along the splitting direction/axis in order to produce a generally balanced tree structure, in which each subspace contains approximately the same number of points. In some cases, the number of points cannot be evenly split (i.e. does not equal 2n), such that one of the points will lie on the median. In this case, the splitting location must then be chosen to be on one side or the other of the median value, such that there will be one more point on one side of the splitting plane than on the other. For example, when a point in a set that is to be split lies on the median value, the splitting location may then be chosen such that the point lying on the median value is located in the left sub-tree of the node representing the splitting plane. This could be achieved by implementing a floor operator/function. Alternatively, the splitting location may be chosen such that the point lying on the median value is located in the right sub-tree of the node representing the splitting plane. This could be achieved by implementing a ceiling operator/function. Consequently, when the number of points in the data set does not equal 2n, the leaf nodes containing a single point will be at different levels within the tree.

Each subdivision therefore splits the space into two sub-spaces which contain approximately an equal number of points (i.e. with approximately half the points in one sub-space and approximately half in the other), and the recursive splitting of the space stops when the number of points in each sub-space is equal to one.

When a binary tree is stored in a memory, each of the branch nodes of the binary tree are associated with a split value (i.e. defining the position on the splitting axis that separates two subspaces) and pointers to its two children, and for a full tree with n leaves n−1 split values are required. However, in the embodiments described herein, the binary tree used to structure the co-ordinate data is stored in a linearized form, wherein the co-ordinate data is stored on its own within an array, with the split values stored in a separate further array, with the order of the co-ordinate data within the array and the split values in the further array defining the structure of the binary tree.

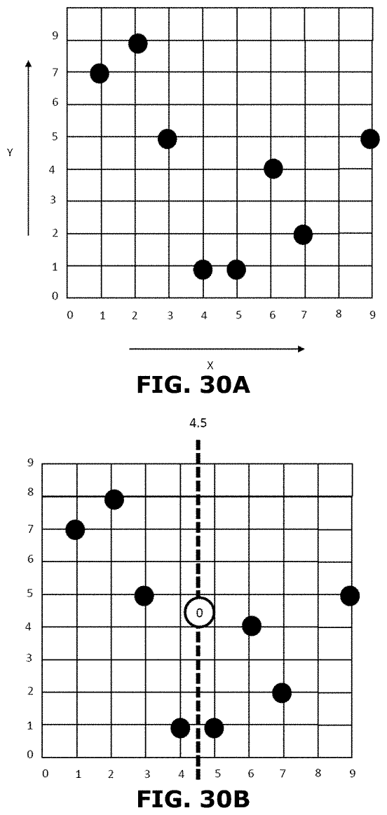

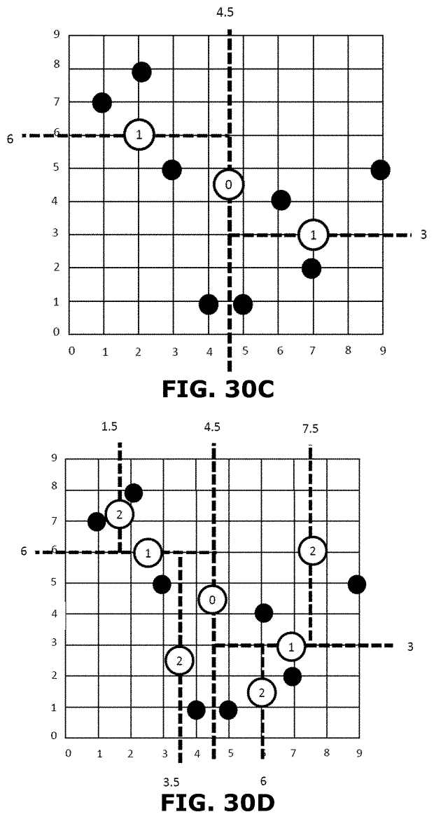

An illustrative example of the processing to generate a linearized tree representation of the data will now be described with reference to FIGS. 30A-D, 3, 4 and 5.

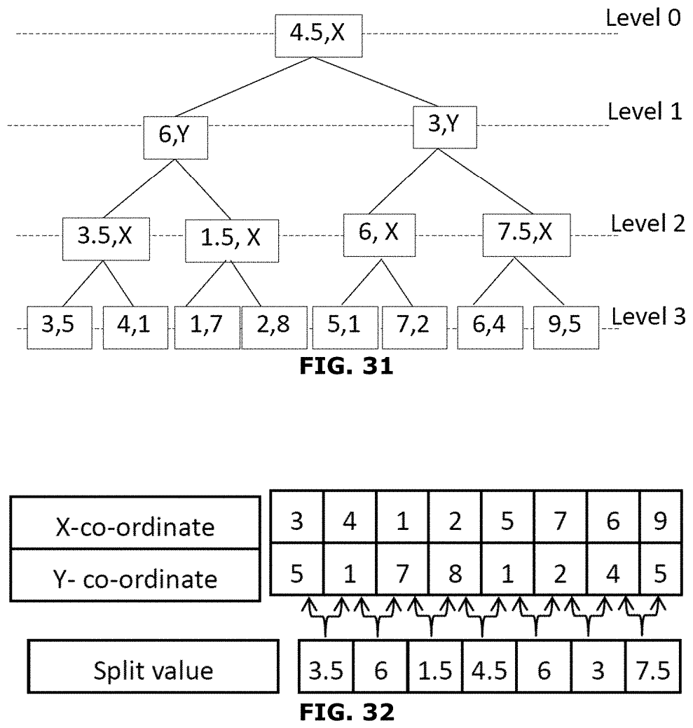

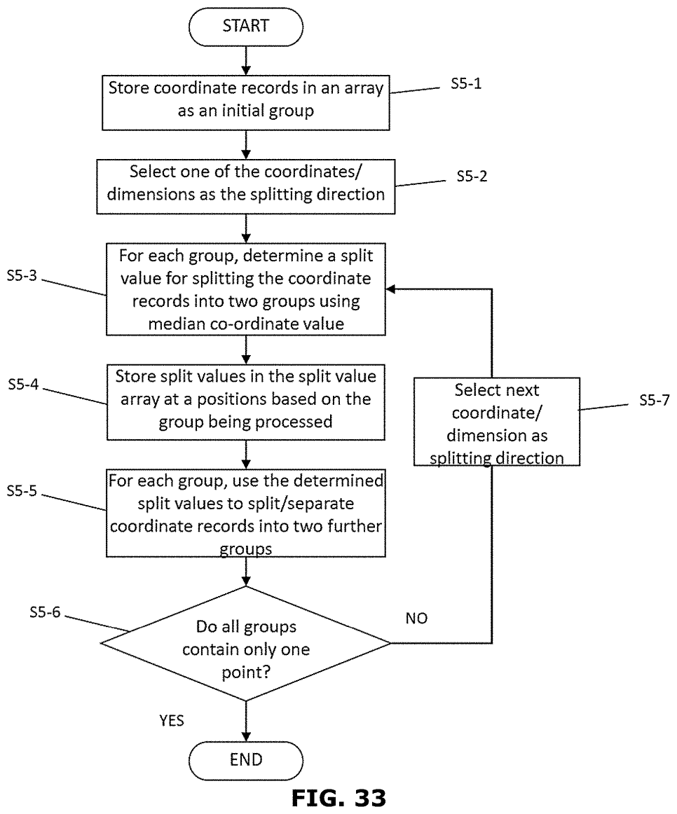

In the following example FIGS. 30A-D are illustrations for explaining the processing involved in generating a tree for an exemplary set of points; FIG. 31 is a schematic illustration of the tree; FIG. 32 is schematic illustration of data stored in memory representing the tree and FIG. 33 is a flow diagram of the processing for generating the tree.

FIG. 30A illustrates a space representation of eight points/co-ordinate records, each defined by a pair of co-ordinates (i.e. a tuple), for which the co-ordinate data represented in an array is:

TABLE 1

| | | | | | | | | |
|---|---|---|---|---|---|---|---|---|
| X-co-ordinate | 5 | 2 | 1 | 3 | 6 | 4 | 7 | 9 |
| Y-co-ordinate | 1 | 8 | 7 | 5 | 4 | 1 | 2 | 5 |

In a first split of the recursive splitting process, the splitting direction in this example is chosen to be along the x-axis. The median value that is to be used to split the space along the x-axis is then calculated. In this example, as there are an even number of points in the space, this median value is the mean x co-ordinate of two of the points (i.e. (4,1) and (5,1)), such that the split value for this level of the tree is 4.5. The data within the array is therefore sorted so that the points/co-ordinate records are effectively split into sections that correspond to the two subspaces defined by the split value. In this example, the points/co-ordinate records that lie to the left of the splitting plane are grouped in the left-hand side of the array (i.e. the left-hand sub-tree), whilst the points/co-ordinate records that lie to the right of the splitting plane are grouped in the right-hand side of the array (i.e. the right-hand sub-tree), such that the array of co-ordinate data becomes:

TABLE 2

| | | | | | | | | |
|---|---|---|---|---|---|---|---|---|
| X-co-ordinate | 1 | 2 | 3 | 4 | 5 | 6 | 7 | 9 |
| Y-co-ordinate | 7 | 8 | 5 | 1 | 1 | 4 | 2 | 5 |

Additionally, this first item of split value data: 4.5 is stored. In this embodiment this split value data is stored in a linear array which is one entry smaller than the number of items of co-ordinate data being processed. So in the above example where eight co-ordinate records are being processed, the split value would be stored as an entry in a seven entry linear array such as illustrated below:

TABLE 3

| | |
|---|---|
| Split value array | 4.5 |

FIG. 30B illustrates the space representation of the eight points/co-ordinate records in which the space has been split into two subspaces by a splitting plane at x=4.5, such that each subspace includes half of the points (i.e. 4) that were present in the space that has been split. The splitting plane is labeled with its depth within the tree (i.e. 0).

In a second split of the recursive splitting process, the splitting direction cycles to the next dimension, such that the splitting direction is along the y-axis. The median values that are to be used to split each subspace along the y-axis are then calculated. In this example, the median value of the left-hand section of the array (corresponding to the left-hand side subspace/left-hand sub-tree) is the mean y co-ordinate of two of the points (i.e. (3,5) and (1,7)), such that the split value for this sub-tree is 6. The median value of the right-hand section of the array (corresponding to the right-hand side subspace/right-hand sub-tree) is the mean y co-ordinate of two of the points (i.e. (6,4) and (7,3)), such that the split value for this sub-tree is 3. The data within the array is therefore sorted so that the points/co-ordinate records in each section of the array are effectively split again into further sections that correspond to the four subspaces defined by the two split values. The array of co-ordinate data therefore becomes:

TABLE 4

| | | | | | | | | |
|---|---|---|---|---|---|---|---|---|
| X-co-ordinate | 4 | 3 | 1 | 2 | 5 | 7 | 6 | 9 |
| Y-co-ordinate | 1 | 5 | 7 | 8 | 1 | 2 | 4 | 5 |

And again, the two new items of split value data are also stored.

TABLE 5

| | | | |
|---|---|---|---|
| Split value array | 6 | 4.5 | 3 |

FIG. 30C illustrates the space representation of eight points/co-ordinate records in which the two subspaces of FIG. 30B have each been split into two further subspaces, such that there are now four subspaces. The left-hand subspace has been split by a splitting plane at y=6, whilst the right-hand subspace has been split by a splitting plane at y=3. Each of the four subspaces now include two of the points defined by the co-ordinate data.

In a third split of the recursive splitting process, the splitting direction again cycles to the next dimension, such that the splitting direction is along the x-axis. The median values that are to be used to split each subspace along the x-axis are then calculated. In this example, the median value of the left-most section of the array (corresponding to the bottom left subspace) is the average x co-ordinate of two of the points (i.e. (4,1) and (3,5)), such that the split value for this sub-tree is 3.5. The median value of the second-left section of the array (corresponding to the top left subspace) is the average x co-ordinate of two of the points (i.e. (1,7) and (2,8)), such that the split value for this sub-tree is 1.5. The median value of the second-right section of the array (corresponding to the bottom right subspace) is the average x co-ordinate of two of the points (i.e. (5,1) and (7,2)), such that the split value for this sub-tree is 6. The median value of the right-most section of the array (corresponding to the top right subspace) is the average x co-ordinate of two of the points (i.e. (6,4) and (9,5)), such that the split value for this sub-tree is 7.5. The data within the array is again sorted so that the points/co-ordinate records in each section of the array are effectively split again into further sections that correspond to the eight subspaces defined by the four split values. The array of co-ordinate data therefore becomes:

TABLE 6

| | | | | | | | | |
|---|---|---|---|---|---|---|---|---|
| X-co-ordinate | 3 | 4 | 1 | 2 | 5 | 7 | 6 | 9 |
| Y-co-ordinate | 5 | 1 | 7 | 8 | 1 | 2 | 4 | 5 |

With the split value array being updated to accommodate the new items of split value data as below:

TABLE 7

| | | | | | | | |
|---|---|---|---|---|---|---|---|
| Split value array | 3.5 | 6 | 1.5 | 4.5 | 6 | 3 | 7.5 |

Which together corresponds to the data as illustrated in FIG. 32.

FIG. 30D illustrates the space representation of the eight points/co-ordinate records in which the four subspaces of FIG. 30C have each been split into two further subspaces, such that there are now eight subspaces. The bottom left subspace has been split by a splitting plane at x=3.5, the top left subspace has been split by a splitting plane at x=1.5, the bottom right subspace has been split by a splitting plane at x=6, and the top right subspace has been split by a splitting plane at x=7.5. Each of the eight subspaces now includes only a single one of the points defined by the co-ordinate data, and the splitting is therefore complete. FIG. 30D therefore illustrates the space representation of a two-dimensional tree of depth 3 containing eight points.

FIG. 31 illustrates an example representation of the binary tree resulting from the processing of the co-ordinate data given above. In the representation of FIG. 31, the leaf nodes include the co-ordinate data of the points, whilst each branch/internal node defines the splitting axis of the chosen splitting plane and split value/location along that axis. In practice, the root node of the tree corresponds to all of the points in the set, each branch node then corresponds a subset of the points (i.e. the points contained within a subspace defined by one or more splitting planes), and each leaf node contains a single point.

It should be noted that, FIG. 32 illustrates schematically an example of a linearized two dimensional tree structure which includes an ordered array of co-ordinate records and a corresponding ordered array of the split vales determined for the tree. This linearized structure saves a considerable amount of memory as the structure of the tree is stored implicitly rather than explicitly.

FIG. 33 is a flow diagram of the processing implemented by the processor 3 to generate a linearized tree from an array of co-ordinate data that includes co-ordinate, records each of which defines a point by a set of co-ordinates. This generation of the linearized tree structure occurs ‘in-place’. In other words, the process takes the array of co-ordinate data and generates a linearized tree by implementing a number of grouping steps within the array that results in an appropriately ordered array of co-ordinate data, wherein each grouping step effectively creates another level of the tree.

Firstly, the co-ordinate data set is stored in the array and the entire data set is defined as an initial group of co-ordinate records (S5-1). A recursive splitting process is then implemented in which the co-ordinate records are recursively sorted into further sub-groups that each correspond to node of the tree (i.e. the points within a subspace that is defined by a split value), wherein the splitting direction is cycled at each level of recursion. In this regard, the grouping of the co-ordinates implements the creation of a new node in the tree.

To initiate the recursive splitting process, one of the axes/dimensions is selected as the first splitting direction (S5-2). For example, the x-direction may be selected as the first splitting direction. Then, for each set of co-ordinate records, a split value for splitting the co-ordinate records in the set along the splitting direction is determined (S5-3). The split value in this embodiment is determined as the median value of the points being split with respect to their co-ordinates in the splitting axis being used for the splitting plane (i.e. the median of the splitting direction co-ordinate for the co-ordinate records/points in the group). The determined split value is then stored in a corresponding position within the split value array (S5-4).

Once the split value has been determined for a group of points that corresponds to a node of the tree, the co-ordinate records/points within the group are split/separated into two further sub-groups using the split value (S5-5). This splitting of a group into two further groups involves ordering the co-ordinate records within the corresponding section of the array such that those co-ordinate records whose splitting direction co-ordinate is less than the split value are located on the left-hand side of that section of the array, whilst those co-ordinate records whose splitting direction co-ordinate is greater than the split value are located on the right-hand side of that section of the array. This ordering of the co-ordinate records within the sections of the array that correspond to a node of the tree is illustrated above.

After each group has been split, it is then determined whether the number of co-ordinate records/points in each current group is equal to one (S5-6).

When the number of co-ordinate records/points in each current group is not yet equal to one, the next axis/dimension in the co-ordinate set is selected as the next splitting direction and the process returns to step S5-3 in order to continue further splitting each group (S5-7). By way of example, if the first split involved splitting the co-ordinate records along the x-direction, then the second split would involve splitting the co-ordinate records along the y-direction, and so on.

When the number of co-ordinate records/points in each current group is equal to one, the recursive splitting is complete and the process ends.

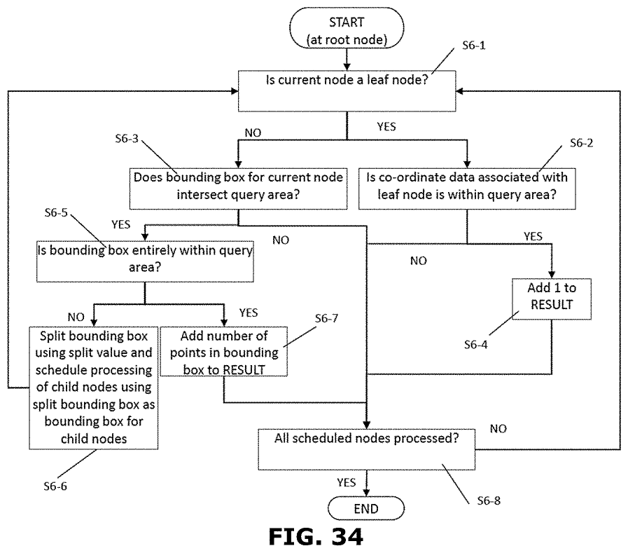

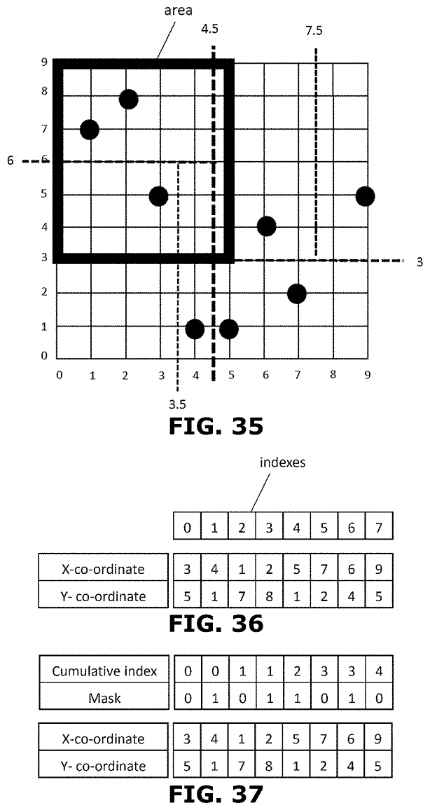

Having processed and stored the linear arrays representing the generated split data and the ordered list of co-ordinate data, this data can then be used to determine the numbers of incidents in an arbitrary area in a highly efficient and rapid manner as will now be described with reference to FIGS. 34-35.

To determine the number of incidents that lie within a particular area, the processor 3 utilizes the stored data in a manner which effectively recursively traverses the branches of the implicit tree structure recorded by the data from the root node to determine which areas associated with the nodes of the tree are contained within the query area. The traversal of each branch of the tree continues until either a leaf node is reached or until it is determined that a bounding box containing all of the points corresponding to a node does not intersect the area defined by the query.

For each branch node traversed (including the root node), a bounding box associated with the node is compared with the query area to determine the extent to which the bounding box associated with the node intersects with the area defined by the query.

Thus, in this way the processing is made to be highly efficient since the implicit tree structure is limited to processing the higher levels of the tree whenever it can be determined that a node lies either wholly in or wholly outside of the query area in question. Thus in the case of very large or very small query areas processing ends rapidly.

The bounding box associated with the root node is defined as being a bounding box which encompasses all of the items of co-ordinate data. For subsequent nodes, bounding boxes are calculated on the fly by using the split values associated with a parent node to split the bounding box associated with the parent node into two halves. Thus at each level within the tree the size of the bounding boxes gets progressively smaller, increasing the likelihood that a bounding box will be found to be either entirely within or entirely outside of the query area.

In order to determine if the bounding box intersects with the query area, all four corners of the bounding box are compared with the query area. If all corners of the bounding box are inside the area then the entire bounding box, and therefore all of the points within the corresponding node, is contained within the area. This will be the case if the bounding box is smaller than the area and located within the area, but also if the area matches the bounding box. If none of the corners of the bounding box are inside the area then the bounding box does not intersect with the area. If some but not all of the corners of the bounding box are inside the area then the bounding box partially intersects with the area.

If the bounding box for the node partially intersects with the area, both child nodes of the node are traversed (i.e. further traversal of the branches extending from the node is required). If it is determined that the bounding box for a branch node is entirely contained with the area, it is determined that all of the points within that bounding box (i.e. that correspond to the node being traversed) are within the original query area. Conversely if the bounding box associated with a node does not intersect with the area, then it is determined that none of the points within that bounding box that correspond to the node being traversed are within the area, and no further traversal of the branch below that node is required.

Finally, if a leaf node in the tree is reached, this will be associated with co-ordinates identifying a single incident. In the case of a leaf node, whether or not that particular incident is within the query area is determined by simply determining if the point corresponding to that the leaf node is contained within the query area.

The total number of incidents within a query area can be determined by keeping a running total of incidents and updating the total whenever a bounding box is wholly contained within the query area or a leaf node is processed and found to be associated with co-ordinate data lying within the query area.

FIG. 34 is a flow diagram of an algorithm for the processing implemented by the processor 3 to calculate the number of points that are within one of a plurality of areas that are to be displayed as part of the image in the manner described above. The recursive traversal of the tree starts at the root node, and therefore starts at a bounding box that encloses all of the points.

Initially, it is determined if the node currently being considered corresponds to a leaf node (S6-1).

If the node currently being considered corresponds to a leaf node, it is then determined if the point defined by the co-ordinate data associated with the leaf node lies within the query area (S6-2). That is to say the co-ordinate data associated with the leaf node being considered is compared with the co-ordinates of the query area. If the co-ordinates are within the query area, then the calculated number of points within the query area (i.e. the “result”) is increased/incremented by 1 (S6-4). The processor then determines if any further nodes are scheduled for processing (S6-8). If this is not the case then the traversal ends and the result is returned as the calculated number of points within the query area.

If any nodes are still scheduled for processing, then the processor repeats the process for the next scheduled node that has yet to be processed (i.e. returns to step S6-1).

If the point defined by the co-ordinate data associated with a leaf node is determined not within a query area, the calculated number of points within the query area (i.e. the “result”) is not changed, and the processor proceeds to determine if all scheduled nodes have been processed (S6-8).

If the node which is being processed is determined not to be a leaf node, it is then determined whether a bounding box associated with the node being processed intersects with the query area (S6-3).

In the case of the initial root node, this bounding box will correspond to the entire area where incidents might be recorded. For nodes at subsequent level, these bounding boxes are defined recursively by the split values associated with their parent node.

Thus, for example, in the case of the area represented by FIG. 30A, the bounding box associated with the root node would correspond to the entire area with corners at points (0,0), (0,9), (9,9) and (9,0). FIG. 30B illustrates bounding boxes associated with the child nodes for which the root node is a parent. That is to say the original bounding box associated with the parent node is divided into two halves based on the split value which in this case is the line at x=4.5. Hence for one of the child node the bounding box will be the box between the points: (0,0), (4.5,0), (4.5, 9) and (0,9) whereas for the other child node the bounding box would be the box between the points (4.5,0), (9,0), (9,9) and (4.5, 9).

The same recursive definition applies at subsequent levels. Thus for example referring to FIG. 30C, the children of the node associated with the bounding box (0,0), (4.5,0), (4.5, 9) and (0,9) are associated with divisions of that box based on the split value y=6 (i.e. the two sub boxes (0,0), (4.5,0), (4.5, 6) and (0,6) and (0,6), (4.5,6), (4.5, 9) and (0,9).

When a bounding box associated with the node currently being processed intersects with the query area being used, it is then determined if the bounding box is entirely contained within the area (S6-5). If this is the case, the calculated number of points within the area (i.e. the “result”) is increased by the number of points that are within that bounding box (i.e. that correspond to the node being traversed) (S6-7) and the processor proceeds to determine whether any further nodes remain to be processed (S6-8).

Where a tree structure is stored as in an array as a linearized tree, this provides a straightforward means for determining the exact number of points that are contained within a bounding box associated with any node in the tree. In such a structure the bounding boxes are defined by the split values associated with the nodes of the tree and an associated ordering of the co-ordinate values.

Thus, for example in the case of the data representing the distribution of co-ordinates such as is illustrated in FIG. 30A, after processing to determine a set of split values such as is shown in FIG. 32, the co-ordinate data from the co-ordinate records will be ordered such as is shown in FIG. 36.

An integer indexing scheme can then be used to determine the number of incidents present in a particular bounding box. More specifically as each item of co-ordinate data is ordered in a particular manner, it is implicitly associated with an index value identifying where within the ordering the co-ordinate data in question appear as is shown in the index in FIG. 36.

Further, just as each node in the tree is associated with a split value, it is also implicitly associated with a range of leaf nodes which can be reached from that node. Thus, for example looking at FIG. 31, the root node which is associated with the split value 4.5 is associated with all of the leaf nodes ranging n FIG. 31 from the leaf node associated with co-ordinates (3,5) to the leaf node associated with co-ordinates (9,5). Conversely, looking further down the tree the node associated with for example the split value 7.5 in the second level of the tree is associated just with a pair of co-ordinates (6,4) and (9,5). In both cases the range of co-ordinates associated with a node is directly determined by the location of the node in the tree.

The number of points or incidents associated with any node can be derived from the index values associated with the co-ordinates associated with a particular node. More specifically, the co-ordinates associated with the highest and lowest index values for leaf nodes which can be reach from a particular node can be determined. The number of incidents which fall within the bounding box associated with that node can then be determined by subtracting the highest index value from the lowest index value and adding one.

Thus, for example all the leaf nodes on the tree can be reached from the root node of the tree. Thus, the highest and lowest indices associated with co-ordinates in the case of the root node in this example would be 0 and 7 and hence the bounding box associated with the root node can be determined to be 7−0+1=8. Similarly in the case of the node associated with value 7.5 in the second level of the tree which is the parent of the leaf nodes associated with the (6,4) and (9,5), these nodes are associated with the index values 6 and 7 and hence the total number of incidents associated with the bounding box associated with that node is 7−6+1=2.

It will be appreciated in such a system, the identity of the two co-ordinates the index values of which need to be checked is directly derivable from the identity of the node being processed.

Further, it is also possible to determine the numbers of incidents within a bounding box where a filter is applied to the data such as might occur if a user were to implement some selection of a subset of the points (e.g. by selecting a specific area of the displayed image or entering some criteria that must be met by the points). In such a system, the selection of a subset of the points can be represented as a mask such as is shown in FIG. 37 wherein the mask includes an array containing a Boolean value for each of the points in the linearized tree structure. The mask therefore allocates a Boolean value to each of the points that specifies whether the point has been selected or not. This mask of Boolean values then can also be used to determine a cumulative index value for each of the elements in the array, with the cumulative index value for each element being the cumulative sum of the Boolean values allocated to each preceding element of the array (i.e. those elements to the left of the element). An example of such a cumulative index for an exemplary mask is shown in FIG. 37.

In such a system, the number of selected incidents lying within a bounding box which correspond to selected points can be determined using a similar approach to that described above but using the values in the cumulative index rather than the simple index positions. Thus, for example in the case of the mask shown in

FIG. 37 and the root node the values extracted would be the values associated with the first and last entries i.e. 0 and 4 and the calculated numbers of incidents would be 4−0=4. In the case of the node associated just with the co-ordinates (6,4) and (9,5) i.e. index values 6 and 7 the number of incidents would be determined to be 4−3=1.

Returning to FIG. 34, when the bounding box associated with the node currently being processed is not entirely contained within the current query area, then the split value associated with the current node being processed is used to split the bounding box two and these two further bounding boxes each of which are associated with the child nodes of the node currently being processed which are scheduled for processing (S6-6). The processor then selects the next scheduled node for processing (i.e. returns to step S6-1).

An exemplification of this process processing the exemplary data of FIG. 30 will now be described with reference to FIG. 35.

FIG. 35 illustrates the space representation of the eight points/co-ordinate records and the subspaces of FIG. 30C, and an example query area of interest (shown by the solid box defined by (0,3), (5,3), (5,9) and (0,9)).

In this example, it can be seen that the bounding box of the root node (i.e. the box (0,0), (0,9), (9,9), (9,0) containing all of the points) and the query area intersects.

Having determined this, the process described above would therefore proceed to consider child nodes of the root node (i.e. the nodes that correspond to the subspaces either side of the splitting plane at x=4.5) by splitting the bounding box enclosing the co-ordinate records into two further bounding boxes and scheduling the a pair of child nodes for processing.

The bounding boxes of the both of these child nodes—the two sub boxes (0,0), (4.5,0), (4.5, 6) and (0,6) and (0,6), (4.5,6), (4.5, 9) and (0,9) (i.e. the division shown in FIG. 30B)—would then be considered. Again it would be determined that the query area intersects with both of these two bounding boxes and the process would therefore proceed to split each of these bounding boxes into two further bounding boxes using the split values associated with the child nodes of the next level in the tree (i.e. by splitting at y=6 and y=3) and schedule the child nodes at the next level of the tree for processing.

At this stage, four bounding boxes for 4 nodes would have to be considered:

(0,0), (4.5,0), (4.5, 6), (0,6)—bottom left

(0,6), (4.5,6), (4.5, 9) (0,9)—top left

(4.5,0), (9,0), (9 3) (4.5,3)—bottom right

(4.5,3, (9,3), (9,9) (4.5,9)—top right

(i.e. the division shown in FIG. 30C).

For the bottom right bounding box (4.5,0), (9,0), (9 3) and (4.5,3) (i.e. corresponding to the subspace below the splitting plane at y=3), it can be seen that this bounding box does not intersect with the query area. When processing the node associated with this bounding box, the process would therefore determine that there are no points within this bounding box that are within the query area and perform no further processing in relation to this bounding box (i.e. no further traversal of the tree below this node would take place).

Conversely, for the top left bounding box (0,6), (4.5,6), (4.5, 9) (0,9) (i.e. corresponding to the subspace above the splitting plane at y=6), it can be seen that this bounding box is entirely contained within the query area. When processing the node associated with this bounding box, the process would therefore determine that all of the points within this bounding box are within the query area. The process would then proceed to determine the index values of the items of co-ordinate data for which the current node is a root node and would subtract the least index value from the greatest value and add one to determine the number of points in the bounding box for the node being processed which in this case would be 2. The running total for incidents in the query area would therefore be incremented by 2 and the process would then perform no further processing of this bounding box (i.e. no further traversal of the tree below this node).

In the case of the other two bounding boxes (i.e. bottom left—(0,0), (4.5,0), (4.5, 6), (0,6) and top right—(4.5,3, (9,3), (9,9) and (4.5,9)) it can be seen that these two bounding boxes intersect with but are not fully contained within the query area.

For the bottom left bounding box (i.e. corresponding to the subspace below the splitting plane at y=6), the process would therefore proceed to traverse the child nodes of this node (i.e. the nodes that correspond to the subspaces either side of the splitting planes x=3.5) by splitting this bounding box into two further bounding boxes at x=3.5—boxes (0,0), (3.5,0), (3.5, 6), (0,6) and (3.5,0), (4.5,0), (4.5, 6), (3.5,6) and scheduling the pair of child nodes to be processed.

Similarly for the top right bounding box, the process would therefore proceed to traverse the child nodes of that node as well (i.e. the nodes that correspond to the subspaces either side of the splitting planes x=7.5) by splitting this bounding box into two further bounding boxes at x=7.5—boxes (4.5,3, (7.5,3), (7.5,9) (4.5,9) and (7.5,3, (9,3), (9,9) (7.5,9) and scheduling the child nodes to be processed.

In this example, processing of each of the nodes associated with the following bounding boxes:

(0,0), (3.5,0), (3.5, 6), (0,6)

(3.5,0), (4.5,0), (4.5, 6), (3.5,6)

(4.5,3, (7.5,3), (7.5,9) and (4.5,9)

(7.5,3, (9,3), (9,9) and (7.5,9)

would therefore be scheduled.

However, all of these bounding boxes correspond to leaf nodes in the tree (i.e., each of the boxes contains a single dot at the position indicated by the co-ordinate data associated with that node.)

Thus, when processing the scheduled nodes the process, rather than further traversing the tree, the process would therefore determine if the point associated with the node being processed lies within the original query area.

In the case of processing the node associated with the bounding box (0,0), (3.5,0), (3.5, 6), (0,6), the processor would identify that the co-ordinate (3,5) associated with the node does lie within the query box and the running total would therefore be increased by one which in the case of this example would make the running total of incidents 3.

In the case of the nodes associated with the other bounding boxes: (3.5,0), (4.5,0), (4.5, 6), (3.5,6), (4.5,3, (7.5,3), (7.5,9) and (4.5,9) and (7.5,3, (9,3), (9,9) and (7.5,9), the associated co-ordinates are (4,1), (6,4) and (9,5) and the process would identify that none of these points lies within the original query area.

At this point, the process would determine that no more nodes were scheduled for processing and would return the current running total of incidents as the total number of incidents, which in this example would be 3.

The above described example describes the processing of a system which calculates the total number of incidents associated with a query area. It will be appreciated that in the case of a system determining the numbers of incidents or points corresponding to a subset of the incidents or points such as represented by the mask on FIG. 37, rather than determining whether the co-ordinates associated with a leaf node fall within the scope of a query area, it would first be determined whether the binary mask value associated with a node was set to one or zero. If the mask value was set to zero, no further processing would then take place. Only if the corresponding mask value was set to one would the process then check whether or not the co-ordinate associated with a leaf node was within the query area being processed.

Thus for example in the case of the query area of FIG. 35 when checking the leaf node associated with the co-ordinate (3,5), i.e. processing the query box (0,0), (3.5,0), (3.5, 6), (0,6), the mask would first be checked and having identified that the entry was associated with a 0 in the mask no further processing would be undertaken.

Similarly in the case of determining the number of incidents in a sub-set which are contained within a bounding box, wholly contained within a query area, the number of incidents would be increased by the numbers of incidents in the bounding box which are also in the subset rather than the total number of incidents which lie within the bounding box.

The above described system can be utilized to generate display data for representing the numbers of incidents in particular areas by interrogating the tree structure for a series of query areas corresponding to different portions of a search space. The results returned as a result of the series of queries can then be converted into display data and displayed on a computer screen. Thus, in this way the above described system can be utilized to generate a data visualization of the intensity of the numbers of incidents associated with a set of co-ordinate records 7.

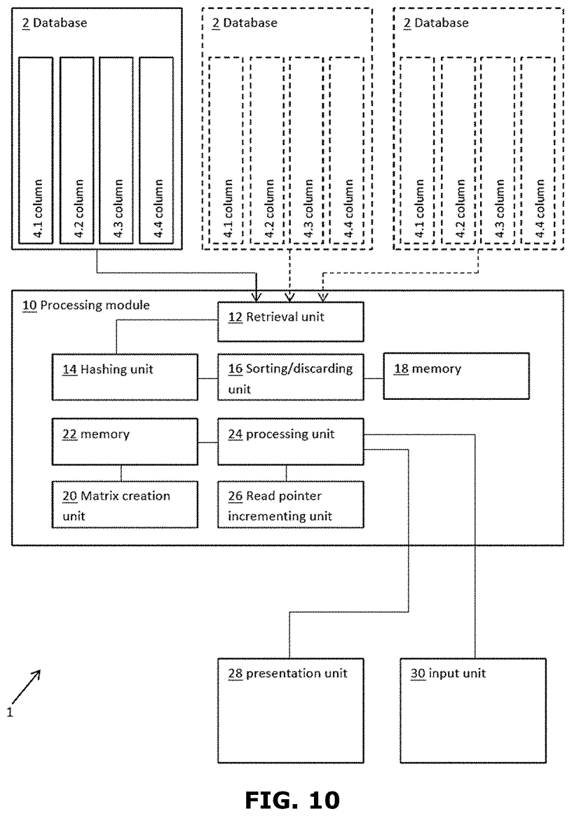

Referring now to FIG. 10, a schematic block diagram of a data analysis system 1 in accordance with an embodiment of the present invention. The data analysis system 1 includes, or is associated with, a database 2. The data analysis system 1 may also include, or be associated with, a plurality of databases 2. The database(s) 2 includes a plurality of columns 4. n (n=1, 2, 3, 4, . . . ) of data entries. A number of columns of the database or databases will be processed by the data analysis system 1. This number of columns is denoted by N. The data analysis system 1 includes a processing module 10. As will be described, the processing module 10 is arranged for determining a measure of overlap between the columns 4. n in the database(s) 2 in a highly efficient manner. To that end, the processing module includes a retrieval unit 12 arranged for retrieving, or receiving, columns 4. n of data entries from the database 2. In this example, the processing module 10 further includes a hashing unit 14 arranged for creating for each column 4. n a hash list including for each data entry in the column a hash value representative of said data entry. In this example, the processing module 10 further includes a sorting unit 16 arranged for sorting the data in the lists. In this example the sorting unit 16 is further arranged for discarding identical values from the lists. The processing module 10 further includes a first memory 18 for storing the lists.

The processing module 10 further includes a matrix creation unit 20 arranged for creating a matrix. The number of columns in the matrix corresponds to the number N of columns to be processed. The number of rows in the matrix corresponds to the number N of columns to be processed. Thus, the matrix is an N×N matrix, having cells Cᵢⱼ, wherein i represents the column number and j represents the row number of the cell in the matrix. The processing module 10 further includes a second memory 22 for storing the matrix.

The processing module 10 further includes a processing unit 24. The processing unit 24 is arranged for assigning a set of N indexed read pointers. Each read pointer is assigned to point to a single associated sorted list in the first memory 18. The processing unit 24 is further arranged for setting each read pointer to the first entry of the associated list. In this example, the sorted hash lists are being processed in ascending order, therefore for each list the first value is the lowest value of that list. In this example, the processing unit 24 is further arranged for determining the index number(s) of the read pointer(s) pointing to the lowest value in the first memory 18. The processing unit 24 is arranged for incrementing the value of cells Cᵢⱼ in the matrix in the second memory 22 having indices i,j, wherein i and j each correspond to any of the index numbers of the pointer(s) pointing to the lowest value. The processing module 10 further includes a read pointer incrementing unit 26 arranged for incrementing the read pointer(s) pointing to the lowest value to point to the next, higher, value(s).

In this example, the data analysis system 1 further includes a presentation unit 28, such as a screen or monitor. The presentation unit 28 may be used to display results of the processing by the processing module 10 to a user of the system 1. In this example, the data analysis system 1 further includes an input unit 30, such as a keyboard, mouse, touchscreen or the like, for inputting commands to the processing module 10.

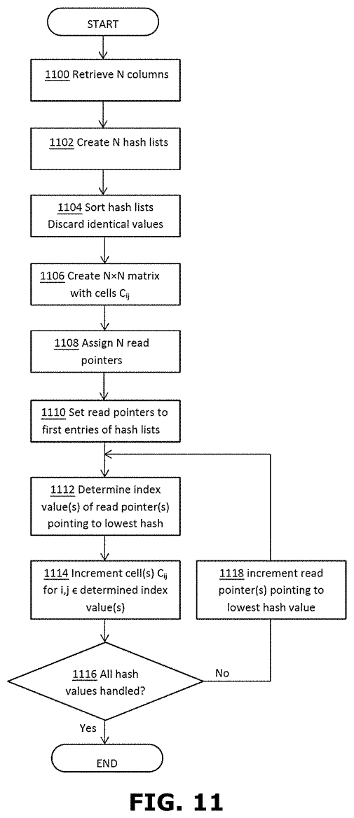

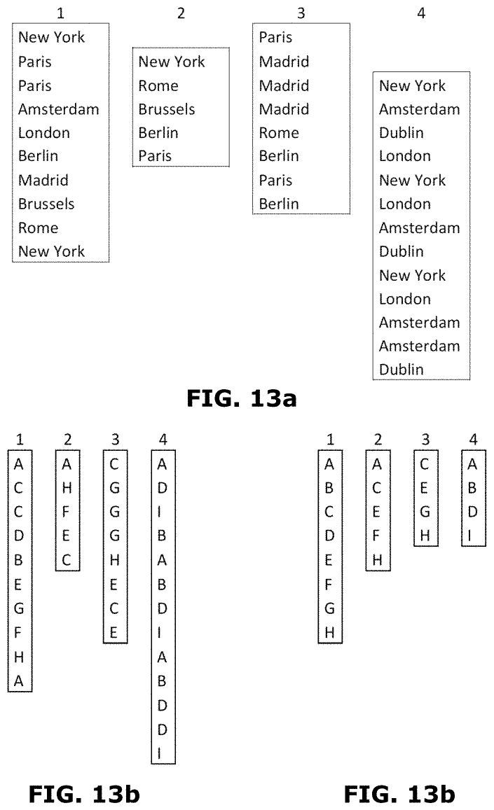

The data analysis system 1 as described thus far can be used according to the following method. Reference is made to FIG. 11 which is a schematic flow chart of a method in accordance with an embodiment of the invention. In step 1100 the retrieval unit 12 retrieves, or receives, the N columns from the one or more databases 2. FIG. 13a shows an example of four columns of data retrieved from a database 2. In step 1102 the hashing unit 14 creates for each column a hash list including for each data entry in the column a hash value representative of said data entry. FIG. 13b shows an example of data in the columns of FIG. 13a having been hashed to hash values. In step 1104 the sorting unit 16 sorts the values in the hash list according to the hash values in the list. In this example, the sorting unit 16 in step 1104 for each list also discards identical values, so that each value is included in the list only once. FIG. 13c shows an example of the lists of hash values of FIG. 13b having been sorted and duplicate hash values having been removed.

It will be appreciated that in this example the processing module 10 retrieves, or receives, columns of data entries from the database(s) and processes these columns into sorted hash lists. It will be appreciated that it is also possible that the processing module 10 retrieves, or receives, pre-processed sorted hash lists. In that case the steps 1102 and 1104 are omitted.

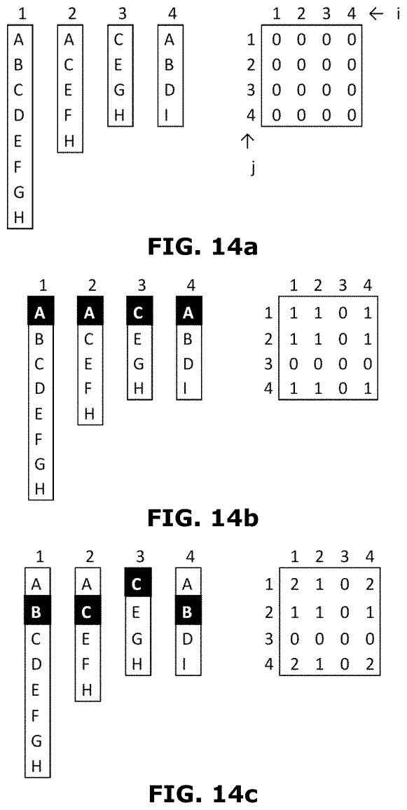

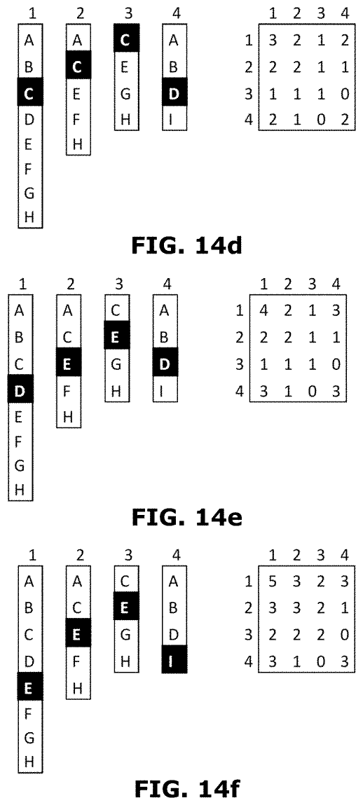

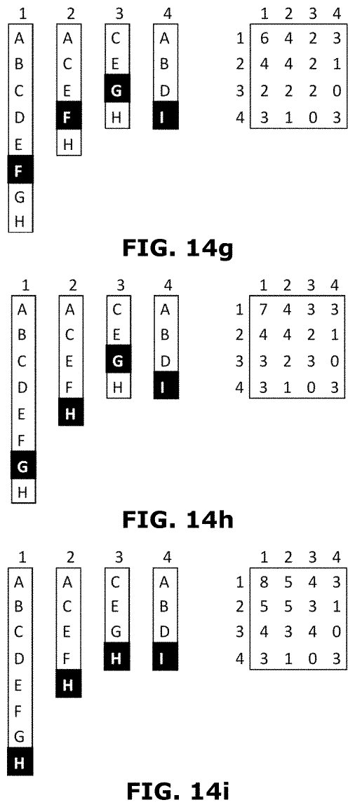

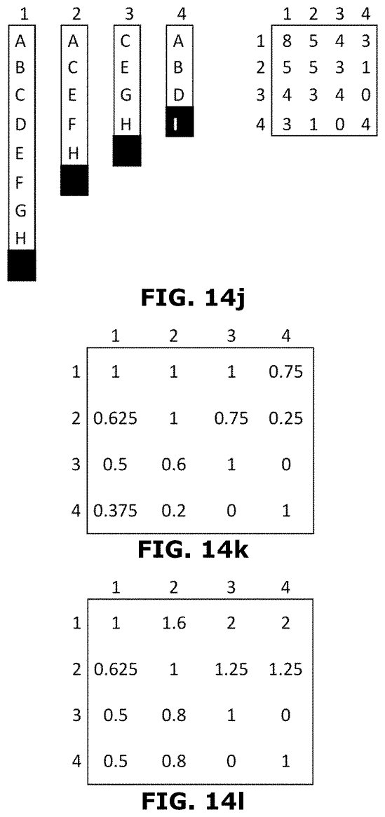

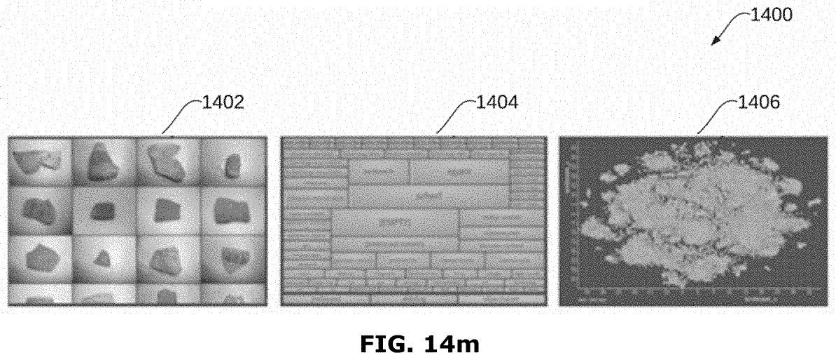

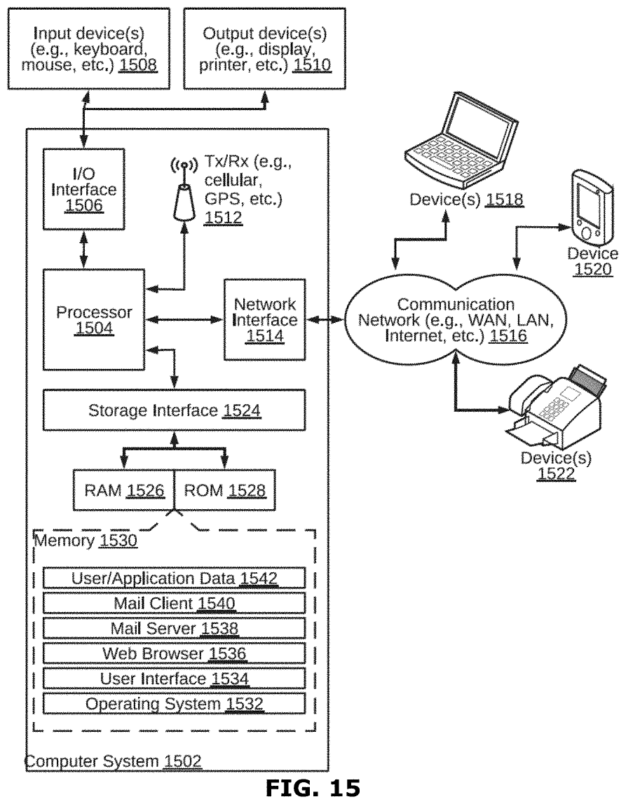

In step 1106 the matrix creation unit 20 creates the N×N matrix and stores the matrix in the second memory 22. FIG. 14 shows on the left hand side the four sorted hash lists of FIG. 13c and on the right hand side the created 4×4 matrix. The matrix has cells Cᵢⱼ, wherein i represents the column number and j represents the row number of the cell in the matrix. The column and row numbers are indicated in FIG. 14a. The matrix is empty, that is all values are set to zero, in the example of FIG. 14a.

In step 1108 the processing unit 24 assigns N read pointer. Each read pointer points to a single associated hash list in the first memory 18. In step 1110 each read pointer is set to point to the first entry of the associated hash list. In FIG. 14b the entry in the hash list to which the respective read pointer points is indicated by a black background. It will be appreciated that in FIG. 14b all read pointers point to the first entries of all respective hash lists.

In step 1112 the processing unit 24 determines the index number(s) of the read pointer(s) pointing to the lowest hash value. In the example of FIG. 14b the read pointers pointing to the lists numbered 1, 2 and 4 point to the value “A”, whereas the read pointer pointing the list numbered 3 points to the value “C”. Therefore, the processing unit 24 determines that read pointers with index numbers 1, 2 and 4 point to the lowest hash value. Next, in step 1114 the processing unit 114 increments the value of cells Cᵢⱼ in the matrix, wherein i and j each correspond to any of the determined index numbers 1, 2 and 4. In FIG. 14b the processing unit 24 thus increments the cells Cᵢⱼ, C₁₂, C₁₄, C₂₁, C₂₂, C₂₄, C₄₁, C₄₂, and C₄₄. In this example, the cell values are incremented by one.

In step 1116 the processing unit 24 determines whether or not all hash values in all lists have been processed yet. Since in the state shown in FIG. 14b not all hash values have been processed yet, in step 1118 the read pointer incrementing unit 26 increments the read pointers having the just determined index numbers to point to the next different hash value(s). This is shown in FIG. 14c. The read pointers 1, 2 and 4 that pointed to the value “A” in FIG. 14b are incremented to point to the next entry in the respective hash lists.

Then the process is repeated. In step 1112 the processing unit 24 determines the index number(s) of the read pointer(s) pointing to the lowest hash value. In the example of FIG. 14c the read pointers pointing to the lists numbered 1 and 4 point to the value “B”, whereas the read pointer pointing the lists numbered 2 and 3 points to the value “C”. Therefore, the processing unit 24 determines that read pointers with index numbers 1 and 4 point to the lowest hash value. Next, in step 1114 the processing unit 24 increments the value of cells Cᵢⱼ in the matrix, wherein i and j each correspond to any of the determined index numbers 1 and 4. In FIG. 14c the processing unit 24 thus increments the cells C₁₁, C₁₄, C₄₁, and C₄₄.

This process is repeated throughout FIGS. 14d-14ⱼ. In FIG. 14i the read pointers all point to the last entries the associated hash lists. The read pointers with index 1, 2 and 3 point to the lowest value “H”. In step 1118 now these read pointers are incremented to point to outside the respective hash lists. The index numbers of these read pointers are ignored when incrementing cells in the matrix in FIG. 14j. Instead of incrementing these read pointers to point outside the respective hash lists, it is also possible to refrain from incrementing these read pointers and ignoring the index numbers of these read pointers when incrementing cells in the matrix in FIG. 14j. In FIG. 14j the last read pointers (index number 4) points to the last entry “I” of the associated hash list. The resulting matrix is also shown in FIG. 14j. The resulting matrix can be presented to a user of the system, e.g. via the presentation unit 28.

It will be appreciated that the matrix is generated in a highly efficient manner by processing and comparing all columns in parallel. This greatly reduces the time in which the matrix is generated, which is of importance when assessing large databases. In the example of FIGS. 13 and 14 the database contains four columns of at most thirteen data entries. It will be appreciated that these extremely low numbers are just for demonstrating the underlying principle in a clear and concise manner. In more practical applications the database can contain tens of thousands or more columns and millions or billions or more separate data entries.

The resulting matrix can also be used for further analysis. The values Cᵢⱼ, with i=j, on the diagonal represent the number of unique values on each hash list. For example, in FIG. 14j C₁₁ has the value “8” corresponding to the number of unique values in the first hash list. Thus also the number of unique values in the first column is eight.

The off-diagonal values, i.e. Cᵢⱼ with i≠j, signify the number of entries that the columns i and rows j have in common. Therefore, the off-diagonal cell with the highest value signifies the combination of columns i and j having the largest number of data entries in common. In FIG. 14j cells C₁₂ and C₂₁ have the value “5”, indicating that columns 1 and 2 have five entries in common. In FIG. 14j cells C₃₄ and C₄₃ have the value “0”, indicating that columns 3 and 4 have no entries in common.

The processing unit 24 may further be arranged for normalizing the values in the cells of the matrix by dividing the value of each cell Cᵢⱼ by the value of Cᵢᵢ. FIG. 14k shows the matrix of FIG. 14j that has been normalized in this way. The normalized cells Cᵢⱼ with i>j signify the percentage of overlap of values in column i found in column j. The normalized cells Cᵢⱼ with i<j signify the percentage of overlap of values in column j found in column i. For example, the value of C₂₁ is “1”, indicating that 100% of the entries of column 2 is also included in column 1. The value of C₂₁ on the other hand is “0.625” indicating that 62.5% of the entries of column 1 is also included in column 2. Thus, clearly column 2 is a subset of column 1. It will be appreciated that the matrix containing the normalized values in the cells is not necessarily symmetrical relative to the diagonal.

The processing unit 24 may further be arranged for processing the cell values as shown in FIG. 14j by dividing the value of cells C_{xy} by the value of cells C_{yx} (division by zero may need to be excluded). FIG. 14l shows the matrix of FIG. 14j that has been processed in this way. The processed cells Cᵢⱼ signify the ratio of the amount of values present in column i relative to column j. For example, the value of C₃₂ is “1.25”, indicating that column 2 includes 25% more data entries than column 3. The value of C₂₃ on the other hand is “0.8” indicating the amount of data entries in column 3 is 80% of the amount of data entries in column 2. The cell Cᵢⱼ or Cⱼ, having the largest normalized value and the processed value closest to one indicates the column j being the closest subset or superset of column i.

Results of such further analysis of the matrix as described above can be presented to a user of the system, e.g. via the presentation unit 28.

If a matrix has been determined for a set of N columns it is possible to add one or more columns to the set of columns and expanding the matrix to also include cell values for these added columns. Then, the retrieval unit 12 retrieves, or receives the further columns. For example a number M columns can be added to the original N columns. The hashing unit 14 and sorting unit 16 create the sorted hash lists for the additional M columns. The matrix creation unit 20 adds N+1^{th} to N+M^{th} columns and N+1 to N+M^{th} rows to the matrix. Hence, an (N+M)×(N+M) matrix is obtained for the N+M columns. The processing unit 24 assigns a set of M additional indexed read pointers in addition to the original N read pointers. Each read pointer points to a single associated sorted hash list, the N+1^{th} to N+M^{th} read pointers pointing to the further hash lists.

In step 1112 the processing unit 24 determines the index number(s) of the read pointer(s) pointing to the lowest hash value. In step 1114 the value of cells Cᵢⱼ in the matrix having indices i,j, wherein i and j each correspond to any of the index numbers of the read pointers pointing to the lowest value are incremented, but only for the cells for which at least one of i and j is in the range of N+1 to N+M. The read pointer(s) pointing to the lowest hash value are incremented. This process is repeated until the last read pointers points to the last entry of the associated hash list. Thus, the original N×N matrix has been expanded to the (N+M)×(N+M) matrix.

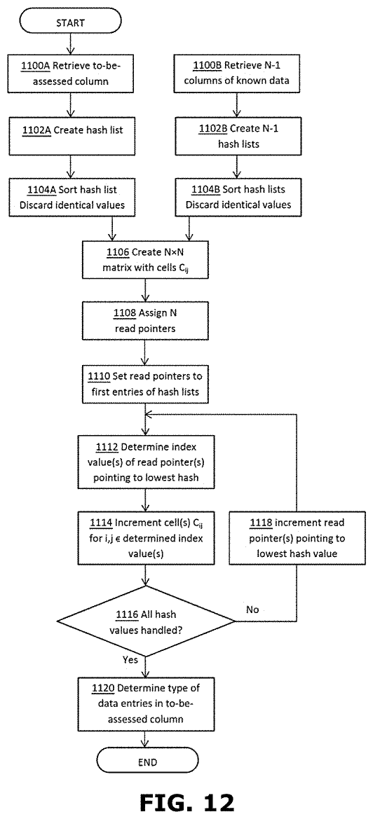

The system 1 and method described thus far can also be used for determining a type of data entries in one or more to-be-assessed columns in a database. Reference is made to FIG. 12. Thereto besides retrieving, or receiving, the to-be-assessed columns in step 1100A also one or more columns containing data entries of known types are retrieved, or received, in step 1100B thus forming a number N of columns. These N columns are processed as described above. Thus, optionally for the to-be-assessed columns a sorted hash list is created in steps 1102A and 1104A, and for the columns of known types in steps 1102B and 1104B. The matrix is created and filled in steps 1106, 1108, 1110, 1112, 1114, 1116 and 1118. Next, it is determined in step 1120, e.g. by the processing unit 24, which cell C_{pq} and/or C_{qp} of the matrix indicates closest conformity between columns p and q, wherein the index p corresponds to the to-be-assessed column or columns. The type of the data entries in the to-be-assessed column is then determined to be similar to the known type of the data entries in the column corresponding to the other index q. It will be appreciated that in this example the processing module 10 retrieves, or receives, columns of data entries from the database(s) (steps 1100A and 1100B) and processes these columns into sorted hash lists (steps 1102A, 1104A, 1102B and 1104B). It will be appreciated that it is also possible that the processing module 10 retrieves, or receives, pre-processed sorted hash lists. For instance, the columns of data entries of known types may be retrieved, or received as sorted hash lists. Also, the to-be-assessed columns may be retrieved, or received, as sorted hash lists. The hash lists of the known types may e.g. be (permanently) stored in the first memory 18.

Determining which cell C_{pq} and/or C_{qp} indicates closest conformity for example is done by determining which cell C_{pq} and/or C_{qp} has the highest value. The highest value indicates the list q having the largest number of data entries in common with column p. A large number of data entries of a known type corresponding to data entries of an unknown type may indicate a high chance, or correlation, that the unknown type is similar or identical to this known type.

Alternatively, or additionally, the values in the cells in column p of the matrix are normalized by dividing the value of each cell Cₚⱼ by the value of Cₚₚ. Determining which cell C_{pq} indicates closest conformity then for example is done by determining which cell C_{pq} has the highest normalized value. The highest normalized value indicates the list q having the largest percentage of data entries in common with column p. A large percentage of data entries from a list of a known type corresponding to data entries of an unknown type may indicate a high chance, or correlation, that the unknown type is similar or identical to this known type.

Alternatively, or additionally, the values of the cells in row p and/or column p are processed by dividing the value of cells C_{xy} by the value of cells C_{yx}, The value of the thus processed value of Cᵢⱼ signifies the ratio of the amount of values present in column i relative to the amount of values present in column j. The cell C_{pq} or C_{qp} having the largest normalized value and the processed value closest to one indicates the column q being the closest subset or superset of column p.

In the foregoing, the invention has been described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

It will be appreciated that the retrieval unit, hashing unit, sorting unit, discarding unit, processing unit, matrix creation unit, and read pointer indexing unit can be embodied as dedicated electronic circuits, possibly including software code portions. The retrieval unit, hashing unit, sorting unit, discarding unit, processing unit, matrix creation unit, and read pointer indexing unit can also be embodied as software code portions executed on, and e.g. stored in, a memory of, a programmable apparatus such as a computer.

In the example the first memory 18 and the second memory 22 are part of the processing module 10. It will be appreciated that it is also possible that the first and/or second memory is included in a separate unit associated with the processing module. It is also possible that the first and second memory are both parts of one and the same memory.

In the examples, the sorted lists are processed in an ascending direction. It will be appreciated that it is also possible to process the sorted lists in a descending direction. Then, the processing unit starts by determining the index number(s) of the read pointer(s) pointing to the highest value in the first memory. The processing unit then increments the value of cells Cᵢⱼ in the matrix in the second memory having indices i,j, wherein i and j each correspond to any of the index numbers of the pointer(s) pointing to the highest value. The read pointer incrementing unit then increments the read pointer(s) pointing to the highest value to point to the next, lower, value(s).

In the examples, the values of the cells of the matrix are incremented by one. This may be beneficial so that integer values can be used. It will be appreciated that the values can be incremented by other values as well.

In the example of FIGS. 14a-14j all values of the matrix are incremented in step 1114. It will be appreciated that the resulting matrix as shown in FIG. 14j is symmetrical with respect to the diagonal, that is, C_{xy}=C_{yx}. Therefore, it is also possible that in step 1114 only half of the matrix is updated, for instance only the cells Cᵢⱼ for which or the cells Cᵢⱼ for which Then still the normalized matrix as shown in FIG. 14k can be obtained, due to the known symmetry of the matrix as shown in FIG. 14j.

(7) Reducing Memory Pressure on Data Retrieval, by Way of Using Transposition

When many bit arrays of the same size are given, it is better to put all bits that are in the same position number next to each other, as a single read operation can then retrieve all of the bits at position N over many of the given bit arrays. This storage order is called transposition, as normally the bit position N is the fast-moving axis and the array number A is the slow-moving axis. The bit matrix may be transposed so that the fast-moving axis is the array number A and the bit-position N is the slow-moving parts. This aligns the data structure with the expected retrieval pattern.

(7.1) Transposition Using a Compactor

In some embodiments, the storage folder may include sets of bit arrays that can already be queried. However, a storage retrieval is most efficient in sizes of 512 bytes (or more), there may be waste retrieving a single bit from these files. In such cases, the bit arrays may be transposed (by a compactor). The compactor may make sure all bits at a specific position can be quickly retrieved together. The minimum number of bit arrays to parallelize may be 64, and the maximum may be 4096. However, this may vary based on the supported back end data structures. The bit transposition may take a number of different input files of the same size, and merge them together into one big file. The compactor may perform the various steps, in parallel with the other parts.

By way of an example, the compactor may check the storage folders (for each size M these is a folder) and wait until a folder exists that has at least MinSize (64) bit arrays in it. The compactor may further open a read pointer to each of those files, and create an empty output file in the output storage location. The compactor may further read the first blocks of all arrays. The compactor may further transpose the block (i.e. pack the 64 bits at position N from 64 different files into a single 64 bit unsigned int). the compactor may further write the transposed block out to the output file, and repeat the above steps until all blocks are read. In some embodiments, the compactor may further write a metadata summary that states which original file identifiers are in which position. The compactor may further remove the original files from storage, and repeat the above steps.

Referring again to FIG. 9, a flowchart 900 of a method of accessing a plurality of documents is illustrated, in accordance with another embodiment. At step 902, a compacted file may be received. At step 904, bit positions of compacted file may be adjusted by folding it to the size of the target data structure, if necessary. At step 906, blocks of data may be retrieved for each adjusted bit position that is set. At step 908, retrieved block may be “AND”ed with retrieved block of previous iteration, if applicable. At step 910, a check may be performed to determine if the condition all bits=0 is met. If all the bits=0 condition is met (“Yes” path), then the method may stop. However, if all the bits=0 condition is not met (“No” path), the method may proceed to step 912. At step 912, a check may be performed to determine if all compacted files have been received. If all compacted files have been received (“Yes” path), the method may stop. However, if all compacted files have not been received, (“No” path), the method may proceed once again to step 902, and the process may be repeated.

The above explained algorithms may, therefore, use known components: hashing, bloom filters, hash folding and bit transpositions. The present disclosure provides a composition of these components tuned to the system architecture which is suitable for cloud native landscapes. The logical building blocks include bloom filter, hash folding, and transposition.

(8) Image Clustering Methods Using One of the Above Techniques

Referring now to FIG. 14m, a process 1400 of organizing a set of images is illustrated, in accordance with an embodiment. The set of images may be organized using by image clustering (“PixelSorter”) using deep learning so that a user can quickly identify groups of similar images, and can quickly label these. Block 1402 shows one or more images. Block 1404 shows one or more attributes that are specific (word wall patent) to the selected set of images. Block 1406 shows image clustering that includes little groups of consistent images. In some embodiments, the above process may be applied for document clustering, using a paragraph and document level organization, which can be used to sift through large collections of contracts etc.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

(9) Computer System for Implementing Various Embodiments

The disclosed methods and systems may be implemented on a conventional or a general-purpose computer system, such as a personal computer (PC) or server computer. Referring now to FIG. 15, a block diagram of an exemplary computer system 1502 for implementing various embodiments is illustrated. Computer system 1502 may include a central processing unit (“CPU” or “processor”) 1504. Processor 1504 may include at least one data processor for executing program components for executing user or system-generated requests. A user may include a person, a person using a device such as such as those included in this disclosure, or such a device itself. Processor 1504 may include specialized processing units such as integrated system (bus) controllers, memory management control units, floating point units, graphics processing units, digital signal processing units, etc. Processor 1504 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 1504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1504 may be disposed in communication with one or more input/output (I/O) devices via an I/O interface 1506. I/O interface 1506 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (for example, code-division multiple access (CDMA), high-speed packet access (HSPA+), global system for mobile communications (GSM), long-term evolution (LTE), WiMax, or the like), etc.

Using I/O interface 1506, computer system 1502 may communicate with one or more I/O devices. For example, an input device 1508 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 1510 may be a printer, fax machine, video display (for example, cathode ray tube (CRT), liquid crystal display (LCD), light-emitting diode (LED), plasma, or the like), audio speaker, etc. In some embodiments, a transceiver 1512 may be disposed in connection with processor 1504. Transceiver 1512 may facilitate various types of wireless transmission or reception. For example, transceiver 1512 may include an antenna operatively connected to a transceiver chip (for example, TEXAS® INSTRUMENTS WILINK WL 1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 1504 may be disposed in communication with a communication network 1514 via a network interface 1516. Network interface 1516 may communicate with communication network 1514. Network interface 1516 may employ connection protocols including, without limitation, direct connect, Ethernet (for example, twisted pair 50/500/5000 Base T), transmission control protocol/internet protocol (TCP/IP), token ring, IEEE 802.11a/b/g/n/x, etc. Communication network 1514 may include, without limitation, a direct interconnection, local area network (LAN), wide area network (WAN), wireless network (for example, using Wireless Application Protocol), the Internet, etc. Using network interface 1516 and communication network 1514, computer system 1502 may communicate with devices 1515, 1520, and 1522. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 1502 may itself embody one or more of these devices.

In some embodiments, processor 1504 may be disposed in communication with one or more memory devices (for example, RAM 1526, ROM 1528, etc.) via a storage interface 1524. Storage interface 1524 may connect to memory 1530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 1530 may store a collection of program or database components, including, without limitation, an operating system 1532, user interface application 1534, web browser 1536, mail server 1538, mail client 1540, user/application data 1542 (for example, any data variables or data records discussed in this disclosure), etc. Operating system 1532 may facilitate resource management and operation of computer system 1502. Examples of operating systems 1532 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 1534 may facilitate display, execution, interaction, manipulation, or operation of program components through textual or graphical facilities. For example, user interfaces may provide computer interaction interface elements on a display system operatively connected to computer system 1502, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 1502 may implement a web browser 1536 stored program component. Web browser 1536 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 1502 may implement a mail server 1538 stored program component. Mail server 1538 may be an Internet mail server such as MICROSOFT® EXCHANGE® mail server, or the like. Mail server 1538 may utilize facilities such as ASP, ActiveX, ANSI C++/C#, MICROSOFT .NET® programming language, CGI scripts, JAVA® programming language, JAVASCRIFT® programming language, PERL® programming language, PHP® programming language, PYTHON® programming language, WebObjects, etc. Mail server 1538 may utilize communication protocols such as internet message access protocol (IMAP), messaging application programming interface (MAPI), Microsoft Exchange, post office protocol (POP), simple mail transfer protocol (SMTP), or the like. In some embodiments, computer system 1502 may implement a mail client 1540 stored program component. Mail client 1540 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 1502 may store user/application data 1542, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments thus provide for reducing/minimizing memory pressure on retrieving data. The techniques may use data itself for building profiles, indexes and linkages, so as to pick up correlations and relations. The techniques further seek to reduce the resource, in particular, memory utilization, thereby making the process of document accessing compatible with cloud-based storage. The techniques may allow building indexes of large tabular data structures and organizing in such a way that the memory pressure on retrieval is minimal, and that the underlying storage structure is optimized for cloud native services. In other words, the techniques may make search scalable in a cloud-native landscape.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

(10) Implementation of Various Embodiments with Data Cataloging Services

Cloud networks are used to store large quantities of data, and hosting services will often store data for many different business entities, research institutions, non-profit organizations, etc. Due to the volume of data that is stored, retrieving specific collections of data can be a timely and computationally expensive process. Because of this, data is often indexed, or associated with a key value that may be relevant to the data stored. In this way, search functions can search through the abbreviated and less numerous key values rather than having to search through each data point individually.

The invention provides for a means of systematically reducing the number of indices in a data set by using bloom filters, hash folding, and transposition. The reduced number of indices would also result in less memory being used to index a data set, freeing memory space for other operations. Due to the reduced number of indices per data set, the search function will only be able to determine where a data point is not located or probably located. However, due to the probabilistic nature of the function, the amount of time and computing power needed is reduced drastically. The error involved in this method can be reduced to an insignificant level, resulting in a method that is evidently advantageous to conventional methods.

The invention also provides for a query servicing method that is used in tandem with the indexing method. This method is essentially the retrieval counterpart to the previously described indexing method. The query method inputs a query from the user, hashes, folds, and compares it to bit arrays of similar size. If a match is yielded, then the match is mapped to an identifier, which is then added to the query response. This method minimizes the amount of memory needed to service a query.

Many services would have a vested interest in the implementation of these methods, specifically including data cataloging services, such as AWS GLUE, MICROSOFT AZURE DATA CATALOG, and GOOGLE CLOUD DATA CATALOG. These services seek to quickly retrieve relevant data and present it in a fashion that would be suitable for analysis. Services that adopted the inventive indexing and query servicing methods would be able to reduce the time cost of the retrieval process, while simultaneously using less computing power. Because this method is also memory efficient, these services would be able to free storage space for discretionary use. This would ultimately result in a faster, more efficient service that would allow service users to analyze more data over the same period of time.

(11) Embodiments for Computer Interrupt Handling

The combination of bloom filters, hash folding, and transposition provides a compact and efficient way of implementing search indexes. This allows the use of search in memory-restricted contexts such as the cloud-native functions described above. Because of the reduced size of the index tables used in search and the possibility of offline generation of those tables, the invention also applies to other memory-restricted contexts.

Modern computer systems, even quite simple ones, are always doing many things at the same time. Even if not supporting multiple users or applications, computers need to manage their internal state and external connections. This can include monitoring memory usage, checking for system flaws, reading and writing data from external memories and devices, processing user actions (for example on a touch screen), and tracking other sensors and events. Much of a computer's software architecture consists of managing these kinds of tasks while not diminishing its performance on its core applications.

Much of this “housekeeping work” is managed in computer architecture by the use of interrupts. An interrupt is a signal to the computer generated by a hardware of software event. For example, when an external memory device, such as a magnetic disk or flash drive, has data ready for the processor, it signals an interrupt on the computer. When it receives the interrupt, the computer immediately (almost) runs a routine to service the interrupt. This routine, which is called a handler needs to be severely restricted so that it neither reduces overall performance or, importantly, generates any significant interrupts of its own. In practice, interrupt code usually consists of hard-coded logic, usually made up of simple fixed decision trees, which redirect the computer's processing to, for example, read the data from the external device into an internal memory buffer.

In modern architectures, interrupts are also used for managing some accesses to memory. Most architectures make use of memory hierarchies consisting of one or more CPU caches (typically named L1, L2, etc.), external high-speed RAM (random access memory), and finally to slower semiconductor or magnetic memories beyond that. Different levels of memory cache/storage may have significantly different response times and transfer between levels is handled by signals or interrupts of one sort or another. When a requested memory address is in a slower component, an interrupt is signaled to either move data between levels directly or begin such transfers. These interrupts are called “faults” or “misses.” At the lowest level, these interrupts are handled by the CPU hardware, but many are routines to be executed by the CPU itself, which places severe restrictions on the interrupt handlers.

Because of these restrictions, servicing an interrupt is usually a memory-restricted operation. This also means that handlers for interrupts can only use components which satisfy those memory restrictions and have small memory footprints. This ends up precluding most forms of conventional open-ended search against database or text indexes. The present invention can be applied to interrupt handling by pre-computing in-memory table indexes using the combination of bloom filters, hash folding, and transposition described above. The compact nature of the table indexes for search allows handlers to search for patterns with reduced cache misses or page faults. If necessary, the indexes, or parts of them, can be locked in physical memory or explicitly prefetched, removing or reducing the potential for additional interrupts during execution. Too many interrupts, especially recursive ones, can lead to a crippling “interrupt storm” that can severely degrade performance.

In this embodiment, the invention's references to documents or document sections are replaced by actions or logic paths within the handler. Finding a particular match in the table index for event features will cause the handler to take particular actions. For example, a network handler might route a message to a particular address or a device handler might emit a particular response code to the device or signal an error to the operating system.

The use of the invention in interrupt handling allows handlers to make discriminations based on search rather than simple decision tree logic. Using table search indexes within interrupt handlers allows their logic to be based on categories or sequences rather than specific values, enabling them to make better and finer discriminations. This in turn may reduce or obviate additional levels of processing, leading to improved performance and stability.

In addition, the use of pre-compiled table indexes for search allows the interrupt routines to be updated dynamically by other processes. The processes can generate new or more suitable indexes, based on changed context or expectations, which can then be used by active handlers.

For example, in an operating system (such as Linux, MacOS, Windows, or others) an interrupt will be raised when a message is received over a network connection, which could be a wired LAN, a WiFi network, or any of a variety of cellular networks. Using the present invention, an interrupt handler can search a generated table to quickly determine whether the interrupt should be ignored or referred for handling by other threads/processes. These other threads might, for example, pass the message to particular addresses or hosts.

In current implementations of such interrupt handlers, this determination is made by a combination of hard-coded decision logic and simple tables. Using the present invention, routing could use search among a larger number of patterns using the combination of bloom filters, hash folding, and transposition to reduce the memory footprint of the discrimination table.

Because of memory and processing limitations, modern network interrupt handlers usually dispatch based on numeric addresses in the message header. Application of the current invention would allow such handlers to also dispatch on other routing information specified in the message or even embedded in the message content body.

The present invention's probabilistic character meshes well with modern interrupt architectures. Depending on the nature of the interrupt, a handler could refer a positive match (which might be erroneous) to further processing by either the same invention with larger tables or more conventional search mechanisms.

These delegation patterns could be used to improve the reliability of interrupt handling. A given interrupt could be serviced by multiple handlers, each of which uses a different search index to categorize the interrupt's triggering event. The different search indexes could be constructed from partitions of discriminating values explicitly so as to optimize the table size for error probability and filter density. Combining their inputs, by technique such as voting, could yield lower error rates than the individual search indexes.

Because the invention does not produce false negatives, a default decision, such as ignoring the message, would be guaranteed correct based on the compact table in memory.

(12) Computer Security Applications of the Invention

Computer security is a growing area of cost and concern as bad actors strive to utilize or corrupt computer systems to their own ends. One of the primary vectors for this kind of corruption is malware: software which runs on a target computer, often in a privileged mode, to either cause direct damage or to further weaken the target's security.

These kinds of breaches can be destructive, costly, and paralyzing. As a consequence, modern software and hardware architectures include components which work to identify and contain these breaches.

Today's malicious code often strikes very quickly, compromising or disabling systems in a short period of time. The Jigsaw malware, for example, starts deleting files within 24 hours and HDDcryptor infected over 2000 systems at the San Francisco Municipal Transport Agency before detection. To address these threats, operating systems need to proactively and constantly look for threats while not requiring time and memory resources which would compromise performance. The computation and memory profile of this monitoring largely determines how often and where in the program logic these checks occur.

Because malicious code is often reused, either directly or as a component of other attacks or exploits, there are often patterns in the code, signatures, which can be used to flag a potential attack either as or (ideally) before it occurs. Operating systems or their enhancements (such as separate security software) can look for these signatures at various points but need to do so without over-burdening the computer or its applications.

The index table search mechanism afforded by this invention is applicable to automatically flagging potential security threats in a computer operating system. Malicious code often contains identifiable strings or code sequences which indicate that a particular tool or exploit may be being attempted. The present invention could be used to index such signatures in the hashed, folded, and transposed index tables described above. Security components would then use these tables to identify potentially matching exploits and inform the operating system, which could then mobilize both further tests and begin corrective actions. Just as in the interrupt handling embodiment above, the document references are replaced by actions or logic paths based on the matched signatures. In this case, the actions or paths could be based on the particular code signatures detected.

The computational and memory cost of signature identification can be significant, especially with the growing number of identified threats. Because of this, these security checks are generally only run for specific events, such as when downloading files or opening applications for the first time.

The present invention allows search-based logic to run with a significantly reduced memory. This reduced resource footprint would allow them to be run more often and in a wider range of contexts than currently possible. In turn, this would reduce the risk of the target computer inadvertently running malicious software whose components have identifiable signatures.

A significant advantage of the present invention in this context is the fact that the signatures themselves cannot be retrieved from the in-memory table search index. Because the values in that index are hashed and sampled to generate bit indices, their content cannot be reverse engineered from the data of the search index itself. This is further compounded by hash folding and transposition, which merges potentially discriminating bits and also spreads them across memory.

This irreversibility makes it impossible to easily determine which signatures are actually stored in the index. In addition, adding some random values to tables used for a particular computer can make it nearly impossible to determine whether two index search tables are identical. This can keep malicious software from recognizing possible signatures in the signature indexes.

The obfuscation of the original table data provides a barrier to malicious applications which attempt to analyze the computer's security configuration and also limit the ability of malware developers to reverse engineer the coverage and gaps in a given security configuration.

In processors with secure memory architectures, such as SGX (Intel), SME (AMD), TrustZone (ARM), the constructed tables of signatures can be stored in such memory, make it impossible to corrupt and difficult to access by normal software, which is typically the gateway for malware attacks. Storing the index tables in effectively “read-only” memory protects them from malicious corruption commonly used by malware. Further restriction of the ability to read the tables at all would keep the software from identifying “protective signatures” in the operating system, beyond the inherent security provided by the irreversibility of the invention's search indexes.

A hardware embodiment of the invention could be built into the CPU core itself, monitoring the instruction stream for indicators of malicious code. Depending on the density of the filters in the tables, this could use a cascade of search indexes, where the on-chip implementation operates with a smaller table but signals an interrupt handler (as above) which applies a larger table or different recognition algorithms altogether to the discrimination task.

The invention could also be embodied in a separate device placed on either the motherboard itself and monitoring the flow of instructions and data to the core processing units, raising an interrupt for the CPU when a potentially malicious signature is detected.

(13) Event Monitoring for IoT (Internet of Things) Using the Invention

Computational activity continues to grow exponentially as more devices include general purpose compute capability and those devices are increasingly connected through a variety of methods and protocols. This collective development is often referred to as the “Internet of Things” (IoT). The IoT is an area of huge investment and infrastructure development. This activity is producing innovations in communication, transportation, manufacturing, entertainment, medicine, security, and countless other areas.

The nodes in the IoT need to be small in physical size, low in cost, consume nominal amounts of power, and generate only trace amounts of waste heat. Consequently, IoT nodes generally have limited memory resources and computational power. This provides many other applications for the present invention in IoT computing devices.

These devices include SoC (System on a Chip) hardware components, especially those using general-purpose microprocessors. Such processors include Qualcomm's Snapdragon, Samsung's Exynos, Intel's ATOM, or a variety of proprietary Apple chips used in their phones, watches, and other devices. In these systems, the working memory is on the chip itself and is significantly restricted by both overall size and other device functions which must be supported.

The present invention allows more sophisticated and discriminating processing to be done in these memory-limited contexts on IoT nodes. This improvement can have follow-on effects in the overall IoT system.

This more sophisticated processing can also avoid, in many cases, the need to transfer data from the IoT device to other devices (or the cloud) for analysis. The connective tissue of the IoT is often limited in bandwidth (how much data can be transferred over a fixed interval), availability (when and how often data can be transmitted), and latency (how long responses will take). Reducing communication demands by increasing the sophistication of on-node processing can allow new kinds of applications and new levels of responsiveness. As with the interrupt handling and security scanning embodiments, the search tables can be generated externally and uploaded to the IoT device. It would then be used directly to search local data and signal significant findings to other devices or nodes in the network.

One direct application in the embedded IoT context would be to provide for readily configurable event monitoring. Often an IoT device is performing continuous real-time processing of sensor events, such as audio input to a conversational agent device (such as Amazon's Alexa or Google Home) or video input from an external security camera. The IoT device generally performs some sorts of data processing and then sends the data to external processing nodes, often in the cloud, for the actual analysis. This takes time and network resources as well as raising potential security and privacy concerns.

With the present invention, more of this analysis could happen on the IoT device itself. For instance, the device could search for events in a table of “flagged patterns” which might be a particular utterance (for example, “Alexa”) or a sequence of observed actions (moving around the porch rather than standing in front of the door). This recognition could use pre-compiled but configurable search indexes uploaded to the device and generated by the combination of bloom filters, hash folding, and transposition described above. The context of the device and the data it is scanning would be used to determine optimal filter error rates/density for the generation of the search tables used on the device.

The replacement of hard-coded decision logic with search in pre-generated tables also allows different IoT devices to be easily provisioned with different flagged patterns based on user settings and operational context. The offline index generation process can also create indexes with different levels of precision and accuracy based on the demands and limitations of the overall system. And because different device contexts (for instance, outside an apartment rather than a single-family home) require very different sets of flagged patterns, the overall configurability allows the improvement of task performance without any increase in memory requirements.

For example, a structure for event delegation could allow the propagation of events in one device to other devices with different algorithms or to devices with the same algorithm but larger search tables. As a further refinement, different IoT nodes could be provisioned with different tables and the results of their analysis and search would then be combined by other nodes in the network. This would allow the achievement of improved compound precision in the overall task by partitioning the range of possible inputs and combining their results.

Depending on individual component prices and capabilities, the tradeoffs in table generation could be reduced by generating multiple tables for different devices monitoring the same context or event stream.

What is claimed is:

1. A method of indexing a plurality of documents, the method comprising:
extracting, by a document accessing device, a series of values from each document, allocating, by a document accessing device, a bit array of a predetermined size in a memory,
constructing, by the document accessing device, a bloom filter based on the bit array, wherein each of a plurality of values in the bit array is hashed;
determining, by the document accessing device, density of the bloom filter;
iteratively tuning, by the document accessing device, the bit array until the density of the bloom filter is greater than a predetermined density level; and
storing, by the document accessing device, the tuned bit array in a storage folder, wherein a plurality of bit arrays of same size are grouped together.

2. The method of claim 1, wherein, constructing the bloom filter further comprises turning each value into a N-bit number.

3. The method of claim 2, wherein the N-bit number is 64.

4. The method of claim 1, wherein tuning further comprises:
calculating an error rate associated with the bloom filter; and
iteratively reducing the size of the bit array until the error rate associated with the bloom filter is at a maximum acceptable error rate.

5. The method of claim 4, wherein reducing the size of the bit array further comprises hash folding the bit array to reduce the size of the bit array.

6. The method of claim 5, wherein the size of the bit array is predetermined to accommodate a largest expected variety of data values, based on the predetermined error rate.

7. The method of claim 1, wherein constructing the bloom filter further comprises:
reading the plurality of input values in a streaming fashion;
hashing each of the plurality of input values to generate a plurality of hashed values; and
applying a modular reduction function to each of the plurality of hashed values using an index parameter, to generate a predetermined independent bit positions.

8. The method of claim 1 further comprising:
transposing the bit arrays to enable one or more bits at a position to be retrieved together; and
merging a plurality of different small input files of same size into one large input file.

9. The method of claim 1 further comprising:
identifying a folder having at least size 64 bit arrays, upon checking storage folders each having same size;
opening a read pointer to each of the identified files; and
creating an empty output file in an output storage location.

10. The method of claim 1 further comprising writing a metadata summary stating position of original file identifiers

11. A document accessing device for accessing a plurality of documents, the document accessing device comprising:
a processor; and
a memory communicatively coupled to the processor, wherein the memory stores processor instructions, which, on execution, causes the processor to:
allocate a bit array of a predetermined size in a memory,
construct a bloom filter based on the bit array, wherein each of a plurality of values in the bit array is hashed;
determine density of the bloom filter;
iteratively tune the bit array until the density of the bloom filter is greater than a predetermined density level; and
store the tuned bit array in a storage folder, wherein a plurality of bit arrays of same size are grouped together.

12. The document accessing device of claim 11, wherein, constructing the bloom filter further comprises turning each value into a N-bit number, and wherein the N-bit number is 64.

13. The document accessing device of claim 1, wherein tuning further comprises:
calculating an error rate associated with the bloom filter; and
iteratively tuning the bit array until the error rate associated with the bloom filter is at a maximum acceptable error rate.

14. The document accessing device of claim 13, wherein tuning the bit array further comprises hash folding the bit array to reduce the size of the bit array.

15. The document accessing device of claim 14, wherein the size of the bit array is predetermined to accommodate a largest expected variety of data values, based on the predetermined error rate.

16. The document accessing device of claim 11, wherein constructing the bloom filter further comprises:
reading the plurality of input values in a streaming fashion;
hashing each of the plurality of input values to generate a plurality of hashed values; and
applying a modular reduction function to each of the plurality of hashed values using an index parameter, to generate a predetermined independent bit positions.

17. The document accessing device of claim 11, wherein the processor instructions further cause the processor to:
transpose the bit arrays to enable one or more bits at a position to be retrieved together; and
merge a plurality of different small input files of same size into one large input file.

18. The document accessing device of claim 11, wherein the processor instructions further cause the processor to:
identify a folder having at least size 64 bit arrays, upon checking storage folders each having same size;
open a read pointer to each of the identified files; and
create an empty output file in an output storage location.

19. The document accessing device of claim 11, wherein the processor instructions further cause the processor to write a metadata summary stating position of original file identifiers

20. A non-transitory computer-readable storage medium having stored thereon, a set of computer-executable instructions causing a computer comprising one or more processors to perform steps comprising:
allocating a bit array of a predetermined size in a memory,
constructing a bloom filter based on the bit array, wherein each of a plurality of values in the bit array is hashed;
determining density of the bloom filter;
iteratively tuning the bit array until the density of the bloom filter is greater than a predetermined density level; and
storing the tuned bit array in a storage folder, wherein a plurality of bit arrays of same size are grouped together.
